(19) United States
(12) Patent Application Publication
(10) Pub. No.: US 2009/0015553 A1
(43) Pub. Date: Jan. 15, 2009

(54) IMAGE DISPLAYING APPARATUS, IMAGE DISPLAYING METHOD, AND COMMAND INPUTTING METHOD

(76) Inventors: Keiichiroh Hirahara, Tokyo (JP); Akira Sakurai, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/916,344

(22) PCT Filed: May 31, 2006
(86) PCT No.: PCT/JP2006/311352

§ 371 Date: Dec. 3, 2007

(30) Foreign Application Priority Data
Jun. 3, 2005 (JP) 2005-164414
Jan. 17, 2006 (JP) 2006-009260

(51) Int. Cl. G06F 3/033

(52) U.S. Cl. 345/158

(57) ABSTRACT

A disclosed image displaying apparatus comprises: a photographing unit configured to photograph an image on a screen; a projection image generating unit generating the image to be projected on the screen; an image extracting unit extracting identification information from the image photographed by the photographing unit, the identification information concerning object or figure information; an object recognizing unit recognizing attribute information from the identification information concerning the object information extracted by the image extracting unit; a figure recognizing unit recognizing characteristic information from the identification information concerning the figure information extracted by the image extracting unit; and an operation processing unit operating the projection image generating unit based on the attribute information and characteristic information.

### TECHNICAL FIELD

The present invention relates to a command inputting method, an image displaying method, and an image displaying apparatus, in which mechanism for providing a projection image with a change in accordance with an object and drawing is constructed and a man-machine interface is improved, the provision of change being performed by inputting a command to an apparatus such as an information apparatus and a robot and operating a display image in accordance with identification information of the object and a hand-written figure, by operating the object placed on a display screen on which the projection image is displayed, and by drawing on the display screen using a marker and the like.

### BACKGROUND ART

Today, information apparatuses such as computers have shown remarkable advancement and diversity and various systems using such information apparatuses have been developed and introduced. However, with the progress of such systems, the importance of functional and efficient operations in the entire system is increased. Thus, it is essential to construct a system with a high affinity for humans in which humans operating the system and the characteristics of information apparatuses such as computers are considered and harmony therebetween is achieved. In particular, a user interface, especially the operability of an input/output device is an important element in man-machine systems and the like for efficiently processing complicated tasks in cooperation between humans and machines.

In other words, important elements include an output interface for external expression with information perceptible using the sensory organs of humans and an input interface as a controlling mechanism for allowing the humans to operate information using the hands and feet thereof.

Today, interactions using a mouse and the like have been actively adopted for GUI (Graphical User Interface). However, such GUI is an interaction using sight and hearing involving indirect operations. On the basis of an idea that tactile feedback peculiar to each piece of information is necessary in order to improve direct operability, “Tangible User Interface” for fusing information with physical environments has been proposed. In TUI, a mechanism referred to as Tangible Bit for enabling operations using an object is provided (refer to Non-Patent Document 1).

Further, a system referred to as Sense Table is presented, in which the positions and directions of plural wireless objects on a display screen are detected in an electromagnetic manner. Further, regarding a detection method, two examples of improvement in which a computer vision, for example, is introduced are presented. One of the improvement examples includes a system for accurately detecting an object without responding to the absorption or change of light. The other improvement example includes a system including a physical dial and a corrector for allowing the detected object to correct the status thereof. In addition, the system is configured to detect the change in real time (refer to Non-Patent Document 2).

Also, a disclosed system projects an image on a display screen of a liquid crystal projector and recognizes the object and the hand placed on the display screen using a camera disposed above the display screen.

On the other hand, technological development of virtual reality has been actively promoted in the fields of motion pictures, broadcasting, and the like, in which the movement and forms of modals (virtual objects) represented in CG (Computer Graphics) in a virtual space are controlled based on information about the movement and positions of recognition subjects.

However, special devices such as a special wear and a joystick are necessary so as to enhance the presence in the virtual space and the fusion with virtual objects without discrepancy by controlling the objects in the virtual space has not been realized. In light of this, techniques for controlling control subjects have been disclosed in which information about the positions and directions of recognition subjects is extracted and the control subjects in the virtual space corresponding to the recognition subjects are controlled based on the extracted information (Patent Document 1).

Moreover, in general offices, methods for appealing to the eyes using a projection type display apparatus such as a projector, a black board, or the like are actively used in meetings for decision-making and acquisition of identity, for example. However, there has been a strong request that characters and drawings be added to displayed images in a superimposed manner depending on TPO (Time Place Occasion), and that the added characters and the like be captured as electronic data.

In view of this, disclosed techniques are capable of drawing images on a projection plane where projection images are displayed and provide a photographing unit photographing the drawn images and a synthesizing unit configured to synthesize the images drawn on original images with the original images (refer to Patent Document 2).

Patent Document 1: Japanese Laid-Open Patent Application No. 2000-20193

Patent Document 2: Japanese Laid-Open Patent Application No. 2003-143348

Non-Patent Document 1: “Tangible Bit by Hiroshi Ishii” IPSJ Magazine Vol. 43 No. 3 March 2002

Non-Patent Document 2: “Sensetable by James Patten, Hiroshi Ishii, etc.” CHI 2001, Mar. 31-Apr. 5, 2001, ACM Press

However, according to the techniques disclosed in Patent Document 1, in order to display subjects with movement in the virtual space, it is necessary to prepare real recognition subjects to be displayed and actually move the real recognition subjects in accordance with movement to be provided to the subjects in the virtual space. Also, according to the techniques disclosed in Patent Document 2, although the images drawn on the projection plane can be displayed and saved as electronic data, it is not possible to operate the projected images using the drawn images.

In view of the aforementioned facts, the present applicants have proposed a command inputting method, an image displaying method, and an image displaying apparatus, by which it is possible to avoid the troublesome preparation of the real recognition subjects, input commands for operating an apparatus and a display image in accordance with identification information and movement information of an object, and operate the image displayed on a display screen by simple operations of merely placing the object having a predetermined form on the display screen and manually moving the object without performing troublesome operations such as command inputting using a keyboard and menu selection using a mouse.

### DISCLOSURE OF INVENTION

It is a general object of the present invention to provide an improved and useful command inputting method, image displaying method, and image displaying apparatus in which the above-mentioned problems are eliminated.

A more specific object of the present invention is to provide a command inputting method, an image displaying method, and an image displaying apparatus in which the already filed command inputting method, image displaying method, and image displaying apparatus are improved and the command inputting is possible by other method in addition to the object having a predetermined form.

In order to achieve the above-mentioned objects, the present invention provides an image displaying apparatus comprising: a photographing unit configured to photograph a projection plane on which an image is projected or an object disposed on a back surface thereof and a drawn figure; a projection image generating unit generating an image to be projected on the projection plane; an image extracting unit extracting identification information about the object and figure information about the figure from imaging data photographed by the photographing unit; an object recognizing unit obtaining attribute information about the object from the identification information about the object extracted by the image extracting unit; a figure recognizing unit recognizing types of the figure from the figure information; and an operation processing unit operating the projection image generating unit based on the attribute information recognized by the object recognizing unit and the types of the figure recognized by the figure recognizing unit.

According to the present invention, it is possible to provide an image displaying apparatus capable of performing operations on a projected image using an object and a hand-drawn figure, thereby performing flexible operations utilizing human intuition.

Further, the present invention provides an image displaying method comprising the steps of: photographing for photographing a projection plane on which an image is projected or an object disposed on a back surface thereof and a drawn figure; image extracting for extracting identification information about the object and figure information about the figure from imaging data photographed in the photographing step; object recognizing for obtaining attribute information about the object from the identification information about the object extracted in the image extracting step; figure recognizing for recognizing types of the figure from the figure information; and operation processing for operating a projection image generating unit generating an image to be projected on the projection plane, based on the attribute information recognized in the object recognizing step and the types of the figure recognized in the figure recognizing step.

Moreover, the present invention provides a command inputting method comprising the step of inputting a command to a predetermined apparatus in accordance with attribute information based on identification information about an object and types of a drawn figure.

The present invention is capable of providing a command inputting method, an image displaying method, and an image displaying apparatus in which the already filed command inputting method, image displaying method, and image displaying apparatus are improved and the command inputting is possible by other method in addition to the object having a predetermined form.

Other objects, features and advantage of the present invention will become more apparent from the following detailed description when read in conjunction with the accompanying drawings.

### BRIEF DESCRIPTION OF DRAWINGS

FIG. 1 is a schematic diagram showing an embodiment of an image displaying apparatus according to the present invention;

FIG. 2 is a functional diagram of an image displaying apparatus;

FIG. 3 is a flowchart showing a flow of a process of an image displaying method;

FIG. 4 is a diagram showing a pattern separated from a bottom of an object;

FIG. 5 is a diagram showing an example of an identification code attached to a bottom of an object;

FIG. 6 is a diagram showing an example of a bottom of an object photographed using a CCD camera;

FIG. 7 is a diagram showing a “bottom” displayed after binarizing with a predetermine threshold value such that an entire projection plane is rendered white;

FIG. 8 is a schematic diagram showing an example of imaging data to which character extracting techniques are applied;

FIG. 9 is a diagram showing details of an object recognizing unit;

FIG. 10 is a diagram showing an example of a method for recognizing a figure by a figure recognizing unit, the figure being manually drawn;

FIG. 11 is an example of various figures recognized using a figure recognizing unit;

FIG. 12 is an example of a result of an analysis of figure types;

FIG. 13 is a diagram showing an example of an object placed on a front surface side of a screen and a visible image;

FIG. 14 is a diagram for describing a predetermined distance at an end of a line segment;

FIG. 15 is a diagram showing another example of a determination standard for determining whether an object is at an end of a line segment;

FIG. 16 is a diagram showing an example of attribute information;

FIG. 17 is a diagram showing an example of objects arranged on a screen;

FIG. 18 is a diagram showing an example of a figure in which objects are connected using line segments;

FIG. 19 is an example of a circuit diagram displayed on a screen by an application;

FIG. 20 is an example of a hand-drawn figure for defining attributes of a desired object to other object;

FIG. 21 is an example of a hand-drawn figure by which attribute information of objects is switched for redefinition;

FIG. 22 is an example of a hand-drawn figure for defining the same attribute information to successive object IDs;

FIG. 23 is an example of a hand-drawn figure for defining the same attribute information to plural objects at one time;

FIG. 24 is an example of a hand-drawn figure for examining attribute information of an object;

FIG. 25 is an example of a hand-drawn figure in which a closed loop for surrounding an object is drawn and attribute information of the object is examined;

FIG. 26 is an example of hand drawing for returning an object to an undefined status again;

FIG. 27 is an example of a hand-drawn figure for defining capacity and voltage in accordance with a length of a line segment;

FIG. 28 is an example of a hand-drawn figure for changing attribute numerical values;

FIG. 29 is an example of a flowchart showing a method for detecting an operation based on an attachment/detachment movement of an object;

FIG. 30 is an example of an object to be disposed and an image to be projected on a screen in a wind simulation;

FIG. 31 is an example of a closed loop drawn by a user and plural objects;

FIG. 32 is an example of plural objects arranged by a user and a closed loop drawn by the user;

FIG. 33 is an example of an attribute information storing unit in example 4;

FIG. 34 is an example of line segments with arbitrary forms drawn on a drawing plane;

FIG. 35 is an example of a closed loop filled by an object C disposed in the closed loop;

FIG. 36 is a functional diagram of an image displaying apparatus in example 5;

FIG. 37 is an example of an identification code (circular barcode) attached to an object;

FIG. 38 is a flowchart showing a processing procedure of an object area extracting unit;

FIG. 39 is a diagram showing an example of image data on a photographed object converted to 1-pixels and 1-pixels based on a predetermined threshold value;

FIG. 40 is an example of a flowchart showing a processing procedure of an object recognizing unit;

FIG. 41 is a diagram for describing a pattern analysis in which pixels are scanned in the circumferential direction;

FIG. 42 is an example of a polar coordinate table;

FIG. 43 is an example of a flowchart showing a processing procedure of an object recognizing unit;

FIG. 44 is an example of a operation correspondence table;

FIG. 45 is a functional diagram of an image displaying apparatus in a case where an object attribute information obtaining unit holds an operation correspondence table;

FIG. 46 is a diagram showing a front-type image displaying apparatus;

FIG. 47 is a diagram showing a schematic relationship between the user's view and a cylindrical object placed on a drawing plane;

FIG. 48 is a diagram showing how an anamorphic image projected on a drawing plane is reflected on a cylinder;

FIG. 49 is an example of an anamorphic image projected on a 360-degree area around the circumference of a cylindrical object;

FIG. 50 is an example of an anamorphic image projected on a portion of a cylindrical object;

FIG. 51 is a diagram showing an example of a prismatic object;

FIG. 52 is a diagram for describing a case where a prismatic object is used in an application for simulating a flow of air;

FIG. 53 is a diagram showing a projection image in which images of a building are projected on each surface of a prismatic object;

FIG. 54 is a diagram showing how a user views a transparent object at a predetermined angle;

FIG. 55 is a diagram showing an example of an image to be projected on a bottom of a transparent object, the image being inverted and reversed in advance;

FIG. 56 is a diagram showing how a transparent object functions as a cylindrical lens;

FIG. 57 is a diagram showing a circular barcode in which portions thereof are extracted;

FIG. 58 is a circular barcode attached to a circumferential portion of a transparent object and an image projected on the inside thereof;

FIG. 59 is a diagram showing a third embodiment of an image displaying apparatus according to the present invention; and

FIG. 60 is a diagram showing a third embodiment of an image displaying apparatus according to the present invention.

### BEST MODE FOR CARRYING OUT THE INVENTION

In the following, embodiments of an image displaying apparatus according to the present invention are described, to which a command inputting method and an image displaying method according to the present invention are applied.

### First Embodiment

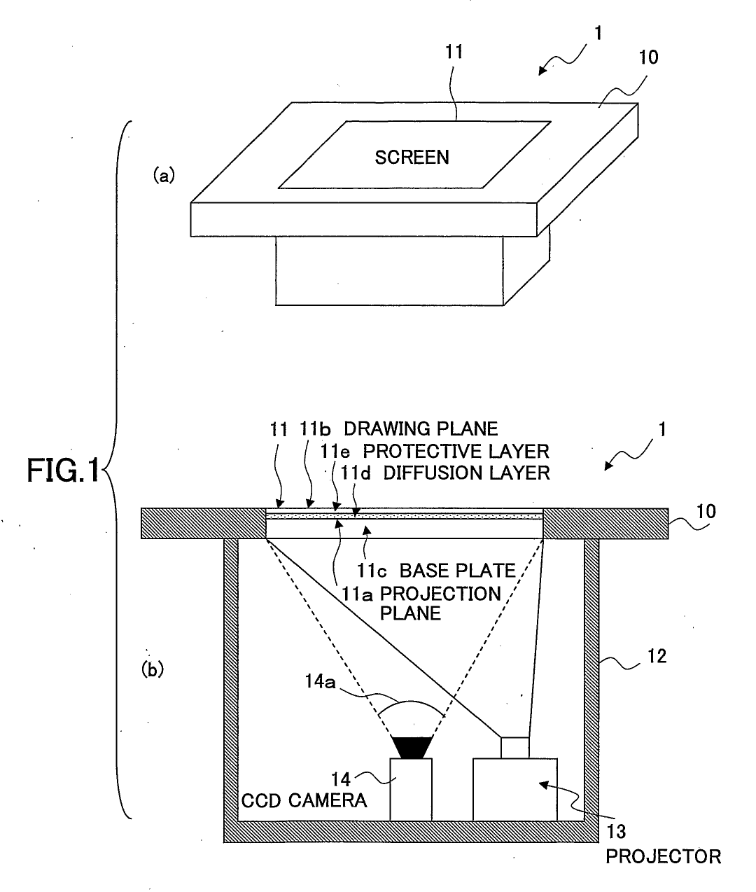

FIG. 1-(a) and (b) is a schematic diagram showing an embodiment of an image displaying apparatus according to the present invention. FIG. 1-(a) shows a schematic perspective view and FIG. 1-(b) shows a schematic cross-sectional view.

As shown in FIG. 1, the image displaying apparatus of the embodiment has a rectangular plane unit 10 including a desk-like display unit 1 and a body unit 2 not shown in the drawings.

The display unit 1 includes, at a central portion of the plane unit 10, a rectangular screen 11 (corresponding to a display screen according to the present invention) in which an image projected from the inside thereof is displayed.

Also, as shown in FIG. 1-(b), the display unit 1 of the image displaying apparatus includes the plane unit 10 having the screen 11 embedded in the central portion thereof, a casing 12 for supporting the plane unit 10, a projector 13 disposed in the inside of the casing 12, the projector 13 projecting an image on the screen 11, and a CCD camera 14 (corresponding to an imaging unit according to the present invention) for photographing the screen 11 from the bask surface side.

The CCD camera 14 disposed in the inside of the casing 12 and the body unit 2 not shown in the drawings are connected using a code and the projector 13 disposed in the inside of the casing 12 and the body unit (projection image forming unit) not shown in the drawings are optically linked.

The screen 11 includes a projection plane 11a on which a projection image is projected, a drawing plane 11b for allowing drawing with the use of a water-color pen or a marker for a whiteboard, a base plate 11c, a diffusion layer lid disposed on the base plate 11c for diffusing light, and a protective layer lie disposed on the diffusion layer lid for protecting the screen 11.

Although both projection plane 11a and the drawing plane 11b are transparent, minute concavity and convexity (diffusion layer lid) is provided to the surface side of the projection plane 11a which is closely bonded to the drawing plane 11b, and when an image is projected on the projection plane 11a, the light thereof passes through with slight scattering. Thus, the projection plane 11a and the drawing plane 11b are configured such that the projected image can be viewed from various angles above the surface side of the screen 11 on which the drawing plane 11b is disposed.

In this case, the surface of the drawing plane 11b may be covered with a transparent protection sheet (protective layer 11e) or may be coated with a transparent paint or the like so as to prevent scratches.

The body unit 2 is capable of recognizing an image of a bottom of an object photographed using the CCD camera 14, obtaining information about the object (identification information and/or movement information), and operating a projection image projected from the projector 13 on the back surface side of the screen 11 in accordance with the obtained information.

The body unit 2 may be prepared exclusively for the image displaying apparatus in the present embodiment, a personal computer in which predetermined software is installed, or disposed in the inside of the casing 12.

The projector 13 is linked to a display of the body unit 2 using an optical system such as a reflection mirror, a beam splitter, or the like, and capable of projecting a desired image formed in the body unit 2 on the projection plane 11a of the screen 11.

The CCD camera 14 is connected to the body unit 2 using a cord via a USB (Universal Serial Bus) interface, for example. The CCD camera 14 is capable of serially photographing a placed object, a drawn figure, and the like on the front surface side of the screen 11, namely, on the drawing plane 11b from the back surface side of the screen 11, namely, from the projection plane 11a at predetermined intervals, thereby obtaining imaging data.

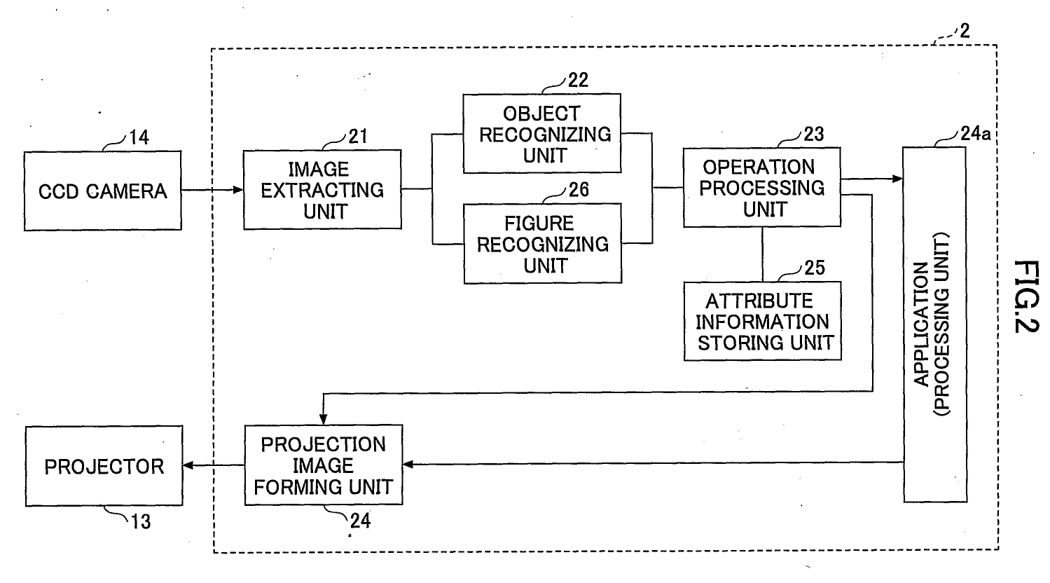

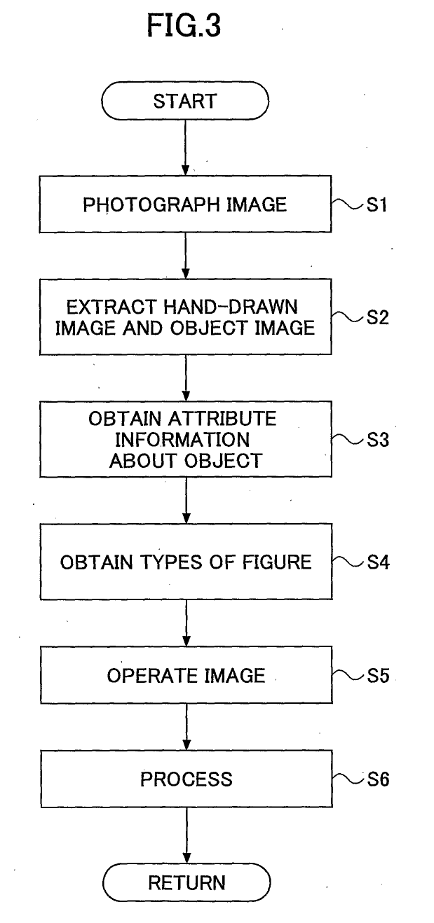

In the following, the image displaying apparatus according to the present embodiment is described with reference to a functional diagram of FIG. 2 and a flowchart of FIG. 3. An image formed in the body unit 2 is projected on the back surface side of the screen 11 using the projector 13 and a person observing from the front surface side of the screen 11 is capable of viewing the projected image.

Further, when the user draws on the drawing plane 11b the CCD camera 14 photographs the screen 11 and the body unit 2 obtains the drawing of the user as image data (bitmap data, for example).

Next, the structure of the body unit 2 is described with reference to the drawings. As shown in FIG. 2, the body unit 2 includes an image extracting unit 21, a projection image forming unit 24, an object recognizing unit 22, a figure recognizing unit 26, an operation processing unit 23, and an application (processing unit) 24a.

The image extracting unit 21 binarizes the imaging data on the image photographed using the CCD camera 14 and extracts the position of the object placed on the screen 11, an outline of the bottom, and an identification code thereof. The projection image forming unit 24 has an interface to the projector 13 and forms an image in accordance with the predetermined application program 24a, the image being projected using the projector 13 from the back surface side of the screen 11. The object recognizing unit 22 performs pattern matching between the identification code extracted by the image extracting unit 21 and a dictionary for pattern recognition stored in a memory in advance, thereby obtaining identification information and information about a direction of the object. The figure recognizing unit 26 extracts information about a figure and a line manually drawn by the user using a marker and the like, extracts characteristics thereof from the information about the figure and line, and recognizes the types of the figure such as a straight line (line segment), circle, wave, and square and sizes thereof. The operation processing unit 23 adds new contents and actions to the image formed in the projection image forming unit 24 in accordance with the predetermined application program 24a and operates the image projected from the projector, based on the identification information and information about the direction of the object obtained in the object recognizing unit 22 and the types and sizes of the figure recognized by the figure recognizing unit 26.

The application 24a corresponds to a processing unit in claims and performs processing based on attribute information referring to regulations for processing in accordance with the attribute information of the object as will be described in the following. As will be described in detail in the following, the attribute information of an object is defined using computer display and contents of processing in association with the identification information of the object, the computer display and contents of processing being performed when the object is recognized on the screen 11.

When the projection image forming unit 24 transmits the image formed in accordance with the application program 24a to the projector 13, the projector 13 projects the image on the back surface side of the screen 11. The projected image can be viewed from the front surface side of the screen 11. As the projection image can be viewed from the front surface side of the screen 11, a person viewing the image arranges plural objects prepared in advance on the front surface side of the screen 11.

According to a flow of processing performed by the image displaying apparatus as shown in FIG. 3, the projection plane 11a is photographed using the CCD camera 14 (S1) and resultant imaging data is transmitted to the image extracting unit 21. The image extracting unit 21 takes out the hand-drawn figure and the object from the imaging data and transmits the hand drawing data to the figure recognizing unit 26 (S2).

Further, the object recognizing unit 22 recognizes the object from the imaging data on the photographed object based on the identification code of the object and obtains attribute information of the object (S3).

The figure recognizing unit 26 extracts characteristics from the extracted information about the figure and line and recognizes the types of the figure such as a line segment, circle, wave, square and the like (S4).

The operation processing unit 23, as will be described in the following, operates the projection image forming unit 24 based on the attribute information of the object and the types of the figure (S5). Also, the projection image forming unit 24 operates the image formed in accordance with the application program 24a and projects the image on the projection plane from the projector 13 (S6). In the following, processing of each step is described in detail.

### [S1 to S2]

In the imaging data photographed by the CCD camera 14, the bottom of the object and the hand-drawn figure are mixed. Thus, the image extracting unit 21 separates the object image and the hand-drawn figure. As will be described in the following, a color for constituting the identification code of the object and a color of a pen upon drawing the hand-drawn figure are known, so that a portion of the imaging data corresponding to the object and a portion of non-object imaging data can be discriminated.

First, a pixel memory for recognizing a hand-drawn figure in which all pixels are initialized in white is prepared. The image extracting unit 21 obtains RGB information about pixels of the obtained imaging data by one pixel. For example, in each pixel, if a G value is not less than 180 (pixel value is assumed to range from 0 to 255), the pixel is judged to have a background color, and the pixel of the imaging data is replaced with white, in other words, the pixel is set to RGB (255, 255, 255). The G value for the judgment is assumed to be an appropriate value in accordance with the surrounding environment and constituent elements of the apparatus.

If the G value is 100<G<180, the pixel is judged to be a hand-drawn figure, so that a corresponding pixel in the pixel memory is set to black, namely, RGB (0, 0, 0) and the pixel of the imaging data is set to white, namely, RGB (255, 255, 255). If the G value is not more than 100, the pixel of the imaging data is set to black, namely, RGB (0, 0, 0).

Thus, according to such processing, imaging data on the object is taken out for the imaging data and imaging data on the hand-drawn figure is taken out for the pixel memory.

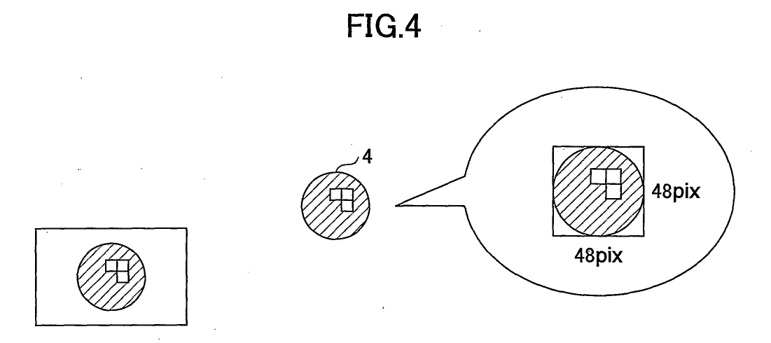

In addition, for example, imaging data for the object and the hand-drawn figure may be taken out by dividing a pattern of the bottom of the object from the hand-drawn figure. FIG. 4 is a diagram showing a pattern separated from the bottom of the object. As the size of the bottom of an object 4 is known (48 pixels×48 pixels, for example), a circle inscribed in a square of 48 pixels×48 pixels is assumed to be a bottom image. Thus, it is possible to divide an image including only the object bottom from an image including only the hand-drawn figure.

The imaging data of the object extracted by the image extracting unit 21 includes the identification code of the bottom of the object. The object recognizing unit 22 analyzes the imaging data and extracts information about an arrangement position of the object, an outline of the bottom, and the identification code. Then, the extracted information is transmitted to the object recognizing unit 22. In this case, the information about the outline of the bottom of the object is also transmitted to the projection image forming unit 24. The projection image forming unit 24 is capable of detecting the fact that the object is placed on the screen 11 based on the information. Accordingly, the projection image forming unit 24 transmits an optical image to the projector 13 at predetermined intervals such that an area including the bottom of the object on the projection plane 11a is rendered uniformly white.

In this manner, by projecting the optical image such that the area including the bottom of the object is rendered uniformly white, the imaging data photographed using the CCD camera 14 is capable of capturing the outline of the bottom of the object and the information about the identification code upon binarization in a clearer manner.

In accordance with the identification code extracted by the image extracting unit 21, the object recognizing unit 22 is capable of obtaining the identification information about the object using the dictionary for pattern recognition. Thus, the object recognizing unit 22 transmits predetermined data depending on the identification information to the operation processing unit 23. The operation processing unit 23 adds the transmitted data together with the types of the figure to the application program 24a and operates the image formed by the projection image forming unit 24.

The “operation of the image” means superimposing, in accordance with the identification code of the object, a new image on an image already projected on the screen 11, solely displaying a new image, and providing, when an object placed on the screen 11 is manually is moved, movement to an image already projected on the screen 11 in accordance with movement information obtained by recognizing the movement of the object. Specifically, the operation processing unit 23 transmits raw data and action data of contents to the projection image forming unit 24. By adding the data to the application program 24a in the projection image forming unit 24, an image of a new object corresponding to the identification code is superimposed or an image already formed is provided with movement in accordance with the locus of a manually moved object.

FIG. 5 is a diagram showing an example of the identification code attached to the bottom of an object 5. The identification code is one form of a two-dimensional code. As shown in FIG. 5, the bottom of the object 5 forms an outline 5a as a closed circular form, for example, such that the object placed on the front surface side of the screen 11, namely, the drawing plane 11b can be readily detected. An identification code 6 is arranged within the outline 5a.

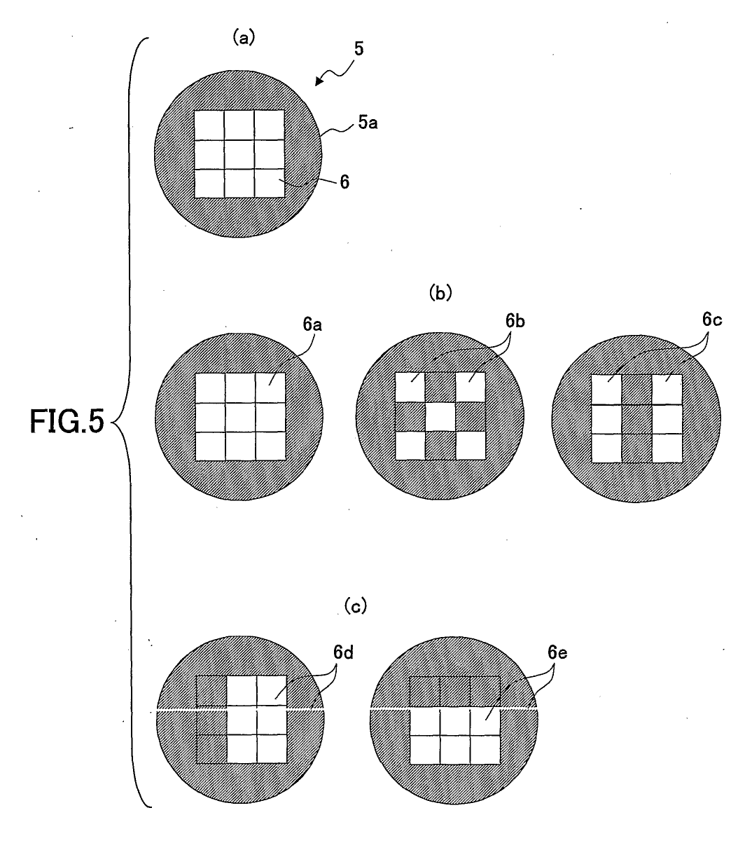

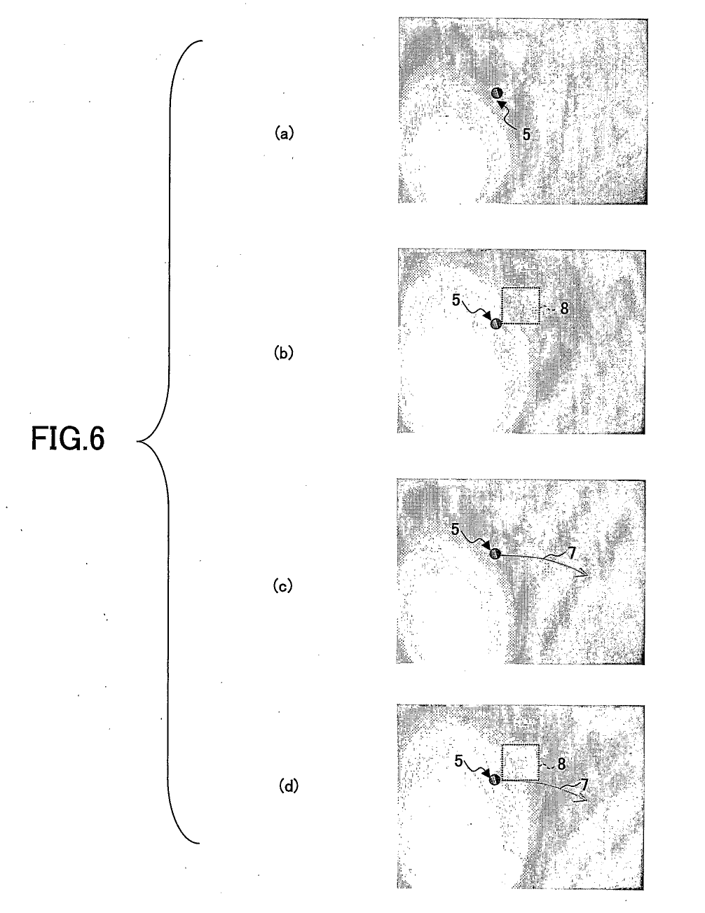

However, if a square including nine sub-squares constitutes the identification code 6 as shown in FIG. 5-(a), it is impossible to adopt three types of forms as shown in FIG. 5-(b) (a square 6a including nine sub-squares, a FIG. 6b in which five sub-squares are alternately arranged, and a FIG. 6c where rectangles in which three sub-squares are arranged in series are arranged in parallel, for example) as the identification code, as they are to be recognized as the same photographic subject based on imaging data through the CCD camera 14 when the identification code 6 is rotated. Also, it is impossible to adopt, as the identification code, forms such as two types of FIGS. 6d and 6e including a rectangle having six sub-squares and a straight line as shown in FIG. 5-(c), as they are to be recognized as the same photographic subject based on imaging data through the CCD camera 14 when each object is rotated.

FIG. 6 is a schematic diagram showing an example of the bottom of the object according to the present embodiment photographed using the CCD camera (an imaging unit in the present invention). FIG. 6-(a) is a diagram showing an image obtained by photographing the bottom of the object placed on the front surface side of the screen. FIG. 6-(b) is a diagram showing an image obtained by photographing the “bottom” 5 of the object such that the entire project plane of the screen is rendered white. FIG. 6-(c) is a diagram showing an image obtained by photographing the “bottom” 5 of the object and a “line” 7 when the object is placed on the front surface side of the screen and a “line (arrow)” is drawn on the drawing plane. FIG. 6-(d) is a diagram showing an image obtained by photographing the “bottom” 5 of the object and the “line” 7 such that the entire project plane of the screen is rendered white.

In the present embodiment, the projector employs a rod integrator as a light source, so that a “rectangular black” 8 is displayed in a highlight portion upon photographing while the entire project plane is rendered white. However, the “bottom” 5 and the “line” 7 have sufficient difference in concentration and both “bottom” 5 and “line” 7 are individually recognizable.

In this manner, when the projection plane of the screen is temporarily rendered white, it is possible to certainly capture the bottom of the object placed on the front surface of the screen.

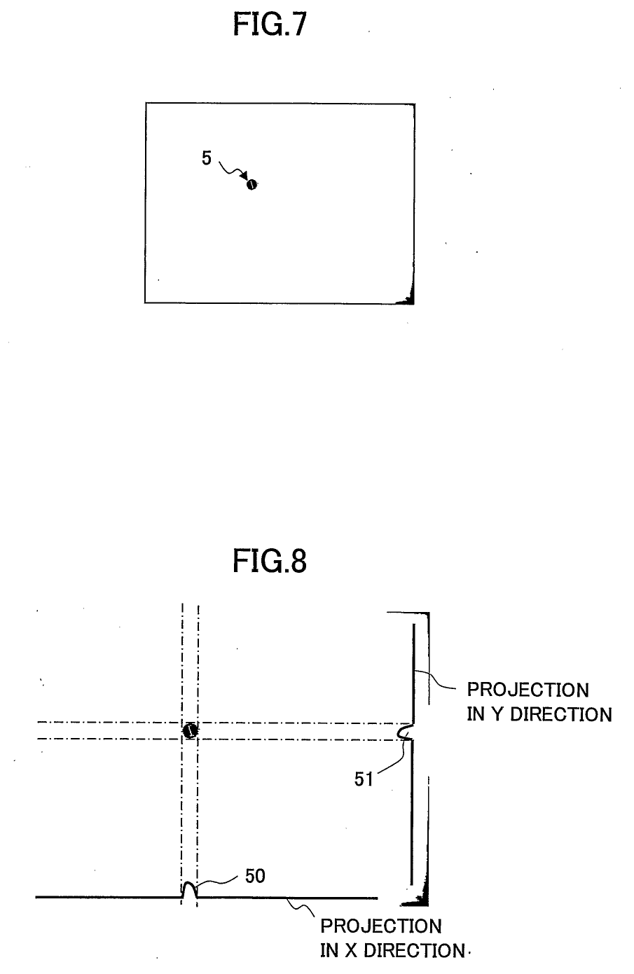

FIG. 7 is a diagram showing the “bottom” 5 displayed after binarizing, with a predetermine threshold value, the imaging data obtained by photographing the bottom of the object such that the entire projection plane is rendered white in FIG. 6-(b).

As shown in FIG. 7, when the imaging data is binarized with the predetermined threshold value, it is possible to certainly capture the outline and position of the bottom, as the rectangular black portion and other noises displayed by using the projector employing the rod integrator as the light source thereof can be eliminated in the highlight portion, for example.

FIG. 8 is a schematic diagram showing an example of the imaging data to which character extracting techniques are applied. As shown in FIG. 8, by creating a histogram 50 of the concentration in X direction in which the imaging data is projected in the X direction and a histogram 51 of the concentration in Y direction in which the imaging data is projected in the Y direction, it is possible to capture the position of the bottom, outline, and identification code of the placed object.

Although FIGS. 7 and 8 show the object in a stationary status, it is possible to obtain movement information when the object is moved by using known methods such as photographing at predetermined intervals with the CCD camera 14 while the entire projection plane 11a of the screen 11 or a predetermined area is rendered white from the projector 13 and obtaining difference of imaging data obtained in each time, obtaining a movement vector of each point of the bottom of the object, or the like.

In this case, when the bottom of the moving object is photographed at certain intervals with the CCD camera 14 while the predetermined area of the projection plane 11a is rendered white, there is a case where a flicker is noticeable due to afterglow, for example. On this occasion, it is possible to handle this phenomenon by detecting the position of the object based on imaging data when a normal image is displayed before the projection plane 11a is rendered white and photographing the entire projection plane 11a while rendering it for a certain period of time after the object is detected, or successively photographing only those areas where the object exist while rendering the areas white.

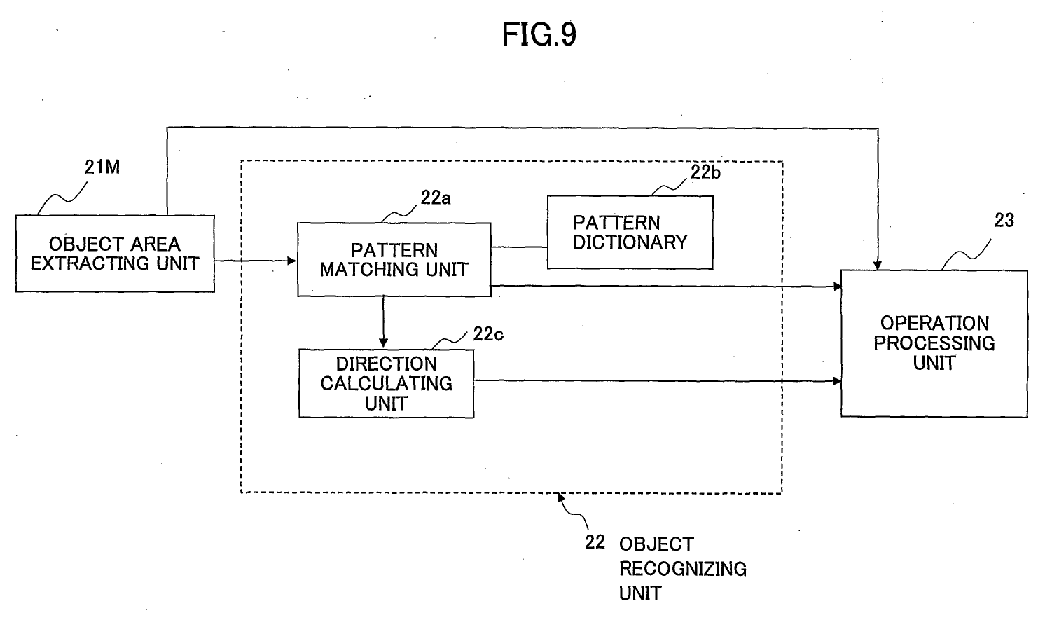

FIG. 9 is a diagram showing the details of the object recognizing unit 22. As shown in FIG. 9, the object recognizing unit 22 includes a pattern matching unit 22a for receiving, from the image extracting unit 21, information about the arrangement position of the object, the outline of the bottom, and the identification code and obtaining identification information about the object and information about the direction of the object using template matching, for example, a dictionary 22b for pattern recognition for recording imaging data on the identification code facing various directions, preparing a dictionary for pattern recognition in which each imaging data is associated with the identification information represented by the identification code, and using the dictionary for pattern matching in the pattern matching unit 22a, and a direction calculating unit 22c for calculating the movement direction of the object based on the imaging data obtained at predetermined intervals.

In this case, the dictionary 22b for pattern recognition is created from images obtained by photographing the identification code of the bottom of the object while the direction of the object placed on the screen is changed. However, the creation is not limited to this method. The dictionary 22b for pattern recognition may be created from images obtained by photographing the object without changing the directions. In this case, the pattern matching may be performed by rotating the identification code information about the object by predetermined degrees, the identification code information being received from the image extracting unit 21. Further, when the pattern recognition is performed at a high speed, by recording the imaging data when the bottom is rotated in the dictionary 22b for pattern recognition, it is possible to recognize the identification code and the direction of the object at the same time. When direction resolution is n, the volume of data to be recorded in the dictionary 22b for pattern recognition is increased to n times. However, the identification code is for operation of an image and it is sufficient to prepare about 100 types, so that the volume of data has little influence on time required for performing pattern matching. Further, data regarding the directions of two identification codes having a high similarity can be improved in accuracy of direction by employing an interpolation method depending on the similarity thereof.

In other words, when similarity of an identification code 1 is r1, a direction thereof is d1, similarity of an identification code 2 is r2, and a direction thereof is d2, a direction to be obtained is represented by:

d=(r1×d1+r2×d2)/(r1+r2)

The pattern matching unit 22a obtains, referring to the dictionary 22b for pattern recognition, information about top two directions in the similarity from information about the identification code of the object received from the image extracting unit 21 and passes the obtained information about the two directions to the direction calculating unit 22c.

The direction calculating unit 22c obtains, based on the information about the arrangement position of the object and the information about the direction of the object extracted from each piece of imaging data obtained at predetermined intervals, a movement vector of the bottom of the object photographed in each time and obtains a movement direction and a movement distance in each time from the movement vector.

In this case, although the movement vector is used, the obtainment of the movement direction and the movement distance are not limited this. For example, the movement direction and the movement distance can also be obtained using difference images.

The position information about the object extracted by the image extracting unit 21, the identification code obtained by the pattern matching unit 22a, and the information about the movement direction obtained by the direction calculating unit 22c are transmitted to the operation processing unit 23. Based on the transmitted information, the operation processing unit 23 is capable of transmitting data to the projection image forming unit 24 for forming an image to be projected on the screen 11 from the projector 13 and operating the image to be projected on the screen 11.

The operation of the image to be projected on the screen 11 can also be performed by drawing on the drawing plane 11b disposed on the front surface side of the screen 11 with the use of a watercolor pen or a marker.

The identification code whose pattern is registered in advance is attached to the bottom of the object used in the image displaying apparatus of the present embodiment. However, the identification code is not necessarily required. Further, an identifier is not necessarily required to be attached to the bottom and each of identification information may be recognized in accordance with the form of the bottom, or the like.

Moreover, although the projection plane of the screen is rendered white upon photographing the identification code, the projection plane is not necessarily required to be rendered white depending on a status of an image to be projected, the contrast between the bottom and the identification code and the image, the wavelength range of each reflected light from the bottom and the identification code, and the sensitivity of the CCD camera.

### [S4]

In the following, description will be given with reference to FIG. 2 again. The figure recognizing unit 26 analyzes a hand-drawn figure based on a bitmap image obtained through the binarization process by the image extracting unit 21. In addition, imaging data may be transmitted to the projection image forming unit 24. The projection image forming unit 24 is capable of detecting drawing on the drawing plane 11b from the information, so that the projector 13 is controlled such that the projection plane 11a is displayed with a uniformly whitish optical image at predetermined intervals.

In this manner, by projecting the optical image such that the drawing plane 11b is rendered uniformly white, the imaging data photographed using the CCD camera 14 is capable of capturing the drawing by the user in a clearer manner when binarized.

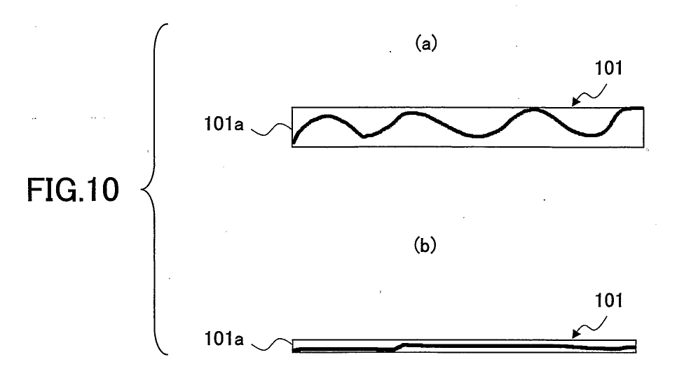

FIG. 10 is a diagram showing an example of imaging data in which a figure drawn by the user is binarized. The figure recognizing unit 26 is capable of drawing a circumscribed quadrangle 101 of the figure manually drawn by the user and classifying the figure into a wave form as shown in FIG. 10-(a) and a straight line as shown in FIG. 10-(b) in accordance with the length of a short side 101a of the circumscribed quadrangle 101. Further, the figure recognizing unit 26 is capable of classifying the figure into a slant line in accordance with the ratio of the area of the circumscribed quadrangle 101 and the length of the diagonal line thereof.

Moreover, the figure recognizing unit 26 may take out the user-drawn figure by performing boundary tracking from the binarized imaging data. In the boundary tracking, black pixels are successively extracted from an image including pixels and converted to a collection of outlines. For example, after performing raster scanning in the image in which white pixels are handled as 0-pixels and non-white pixels are handled as 1-pixels,
(a) an untracked 1-pixel on the boundary is searched for and the pixel is recorded as a start point;
(b) a 1-pixel on the boundary is searched for in the counterclockwise direction from the recorded pixel and the new 1-pixel is handled as marked (boundary point); and
(c) if the new 1-pixel does not correspond to the start point, the process returns to (b) and searches for a new boundary start point or if the new 1-pixel corresponds to the start point, the process returns to (a), searches for other 1-pixel, and records the pixel as a start point.

By repeating this procedure in the image data, a continuous border line can be extracted. When the border line is extracted, the figure formed with the border line can be sectioned in each figure. A section method in each figure can be readily performed using known techniques such as performing a thinning process after the binarization and tracking the boarder line, for example.

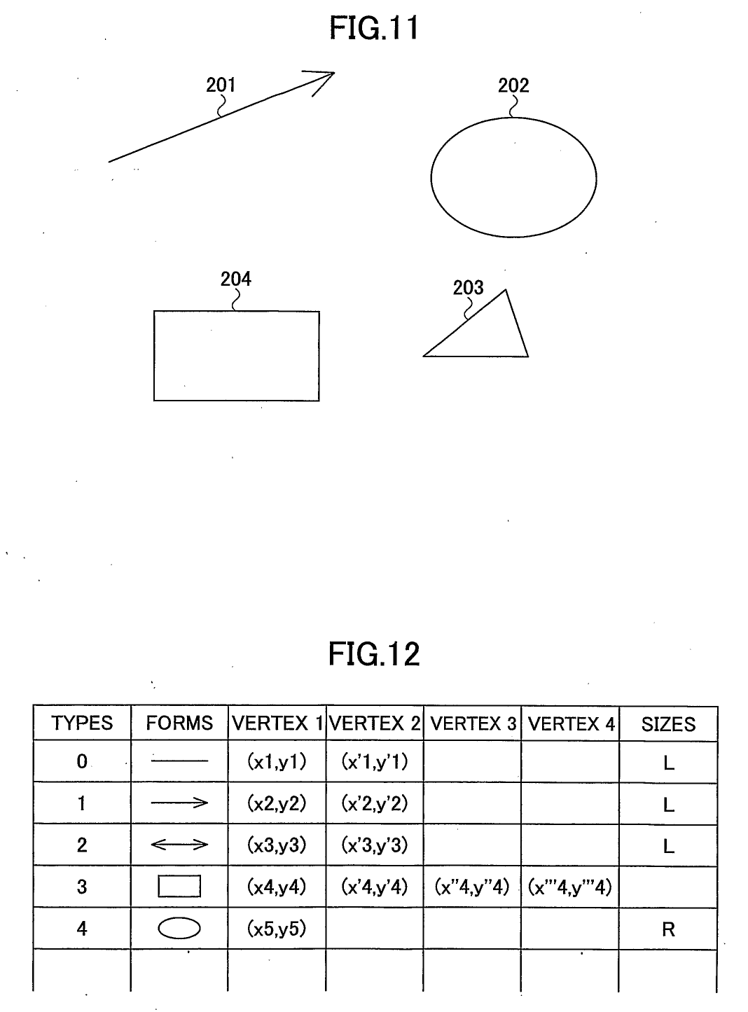

The figure recognizing unit 26 analyzes and obtains types of the figure taken out. The analysis of the figure may be performed by pattern matching, or the figure may be identified by thinning the figure taken out to extract characteristic points and drawing a figure obtained by connecting each characteristic point. The figure recognizing unit 26 recognizes various figures as shown in FIG. 11 as a result of the analysis. In FIG. 11, a single-headed arrow 201, a close loop 202, a triangle 203, and a quadrangle 204 are shown as an example of figure types.

After the analysis of the figure form, information is managed in a memory including coordinates of an end if the form is a line segment, distinction between a start point and an end point if the form is an arrow, coordinates of vertexes if the form is a quadrangle, and central coordinates and values of a radius if the form is a circle.

FIG. 12 is an example of a result of the analysis of figure types. In FIG. 12, vertexes or central coordinates of figures are represented in coordinates in the X axis and Y axis, also sizes L (length) and R (radius) thereof are recorded.

Further, predetermined numeral values (or character strings) for indicating form types are stored in which 0 stands for a simple line segment, 1 for a single-headed arrow, 2 for a double-headed arrow, 3 for a quadrangle, and 4 for a circle. Items of vertexes 1 to 4 store coordinates representing ends in the case of a line segment, coordinates representing vertexes in the case of a quadrangle, and coordinates representing a center in the case of a circle. If the form is a single-headed arrow, coordinates of a start point are stored as vertex 1, namely, as coordinates of a head thereof. Items of sizes store a length in the case of a line segment and numerical data representing a length of a radius in the case of a circle (including an ellipse and the like as long as it is a closed loop).

Address information about the upper left and lower right of a circumscribed rectangle of each figure taken out may be stored as figure information so that information about the form, coordinates of the end, and the like is obtained where appropriate.

In accordance with the aforementioned method, it is possible to obtain the coordinates and type of the figure drawn by the user from the user's drawing. In addition, a method for inputting a figure may be performed by using an apparatus such as a tablet in which a pen-type device for indicating position on the screen and a device for detecting the position are combined, or by obtaining the movement of rendering points using an electronic pen. With the use of the electronic pen, it is possible to obtain stroke information about handwriting without image processing.

### [S5 to S6]

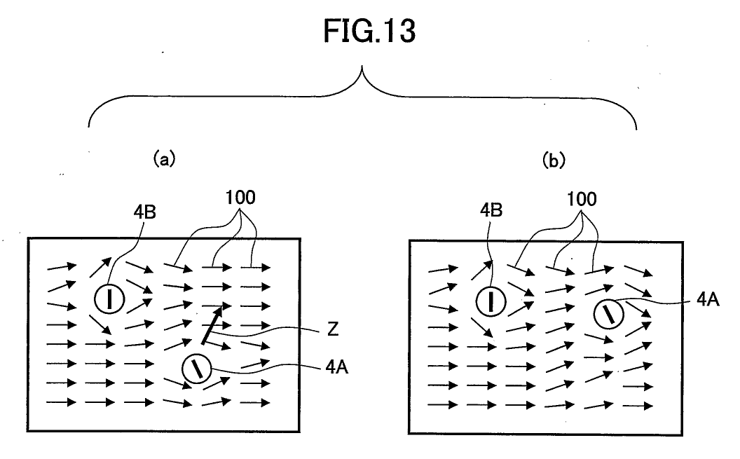

FIG. 13 is a diagram showing an example of the object placed on the front surface side of the screen and a visible image. As shown in FIG. 13-(a), an image where multiple symbols imitating a flow of water are recorded is displayed on the front surface side of the screen. On the front surface side of the screen, an object 4B imitating a wooden pile or a stone is placed on the upper left thereof and an object 4A is placed on the lower right thereof. The multiple symbols 100 imitating a flow of water represent a flow such that they go around the objects 4A and 4B. When the object 4A placed on the lower right is manually moved in the direction of an arrow Z, the multiple symbols 100 imitating a flow of water change the direction of flow such that they go around the object 4A in accordance with the movement of the object 4A. When the movement of the object 4A is stopped at a position shown in FIG. 13-(b), the flow of the multiple symbols 100 imitating a flow of water is settled such that it goes around the stationary object 4A. The flow is not changed thereafter unless the object 4A or 4B is moved.

The present embodiment is described based on the example in which an image displayed on the screen is projected from the back surface in accordance with the identification information, movement information, and figure information obtained by photographing the bottom of the object and drawing. However, such information is not necessarily required to be photographed from the back surface. Further, although the identification information, movement information, and figure information is obtained by photographing, this is not necessarily required to be obtained by photographing but may be obtained by sensing light, electromagnetic waves, and the like emitted from the object.

Moreover, in the present embodiment, the area where the identification information and movement information about the object and the figure are obtained and the area where an image is operated based on the obtained information are the same. However, the area where information is obtained and the area where a-command is input based on such information and an object of some sort is operated may be separate. In other words, it is also possible to transmit a command to a remote robot, mechanical apparatus, information device, and the like via a network by moving the object in accordance with the obtained identification information and movement information, thereby performing remote control.

By combining the thus obtained figure information and attribute information, the image displaying apparatus according to the present embodiment performs operations on a computer and operates the attribute information about the object based on the figure information in particular. In the following, description is given with reference to examples.

### EXAMPLE 1

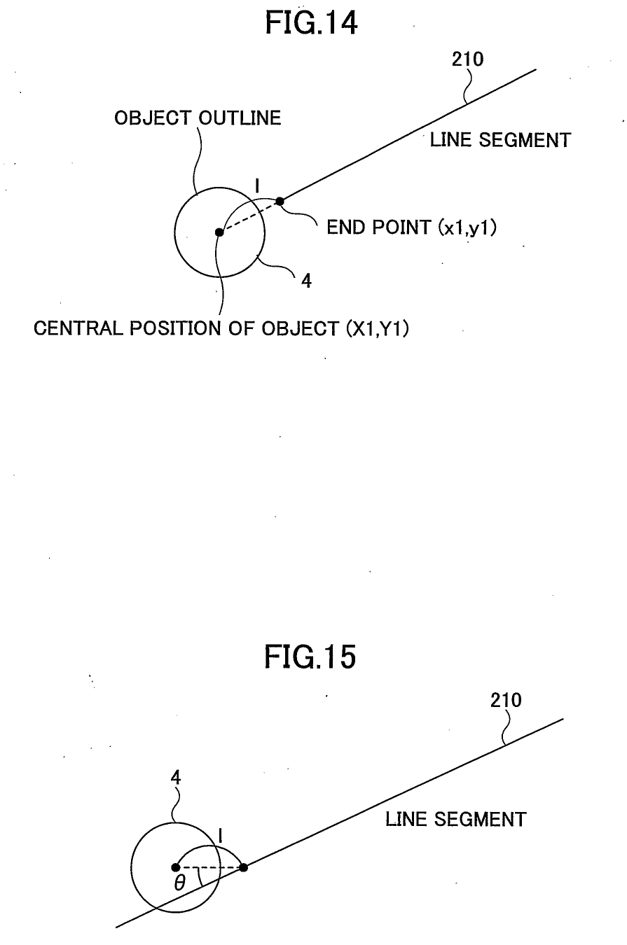

First, in order to extract a hand-drawn figure and an object in an associated manner, determination of the distance between the hand-drawn figure and the object is described. FIG. 14 is a diagram for describing a predetermined distance at an end point of a line segment. When the distance between a start point or an end point of a line segment 210 as a terminal point and the object 4 is not more than a predetermined distance, the predetermined distance refers to a distance 1 between the end point (x1, y1) of the line segment 210 and central coordinates (x1, Y1) of the object 4. When the distance 1 is within a predetermined pixels determined in advance (30 pixels, for example), the object 4 is determined to exist at the end point of the line segment 210. The predetermined distance between the end point of the line segment and the center of the object is not limited to this, as the distance varies in accordance with the size of the bottom of the object in the image, the resolution of the photographing camera, the size of the screen, and the like.

Moreover, a criterion for determining the object 4 at the end point of the line segment 210 may be, as shown in FIG. 15, an angle within ±90 degrees formed by a straight line connecting the end point (x1, y1) of the line segment to the center of the object and the line segment 210 in addition to the distance between the central coordinates of the bottom of the object and the coordinates of the end point of the line segment. Regarding the angle, 90 degrees is merely an example and the angle is preferably changed to a suitable value for operation as appropriate.

In the present example, description is given with reference to a simulation application of an electric circuit, for example. An object 41 is a resistor of 10Ω, an object 42 is a power source (battery) of 1.5V, and an object 43 is a capacitor of 10 F. No attribute information is defined for objects 44 and later.

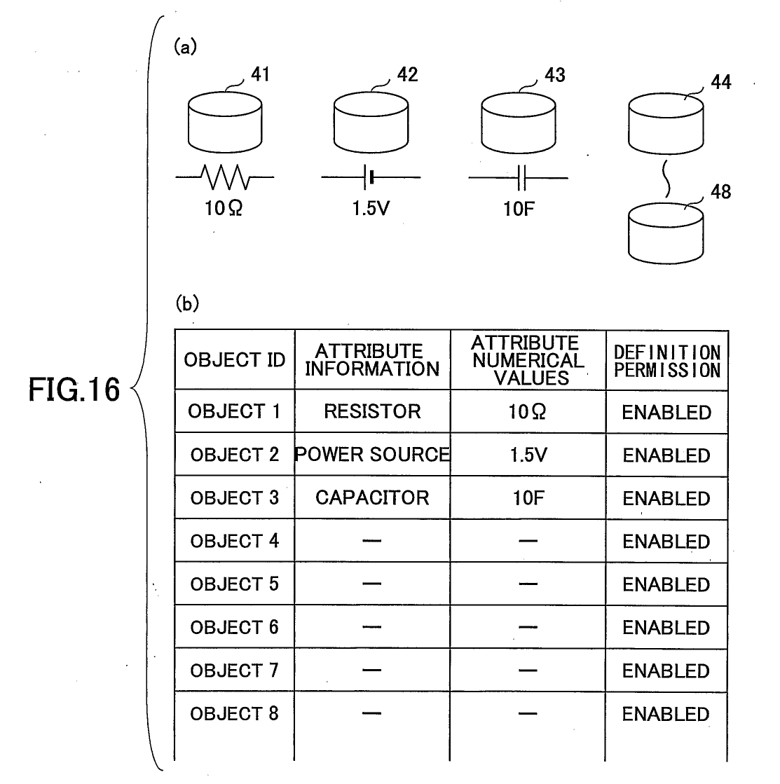

FIG. 16 is an example showing attribute information of objects defined in this manner. As shown in FIG. 16, the 10Ω resistor, 1.5V battery, and 10 F capacitor are included in attribute information defined in the objects 41 to 43, respectively. Symbols for representing attributes shown below the objects 41 to 43 are used for description.

Also, in an attribute information storing unit, attribute information as shown in FIG. 16(b) is stored. Object IDs indicate identification information of objects, attribute information indicates the contents of attributes defined in the objects, attribute numerical values indicate numerical values when parameters of size are set in the attributes, definition permission indicates whether the definition of attributes (renewal, initialization, change, and the like) is permitted.

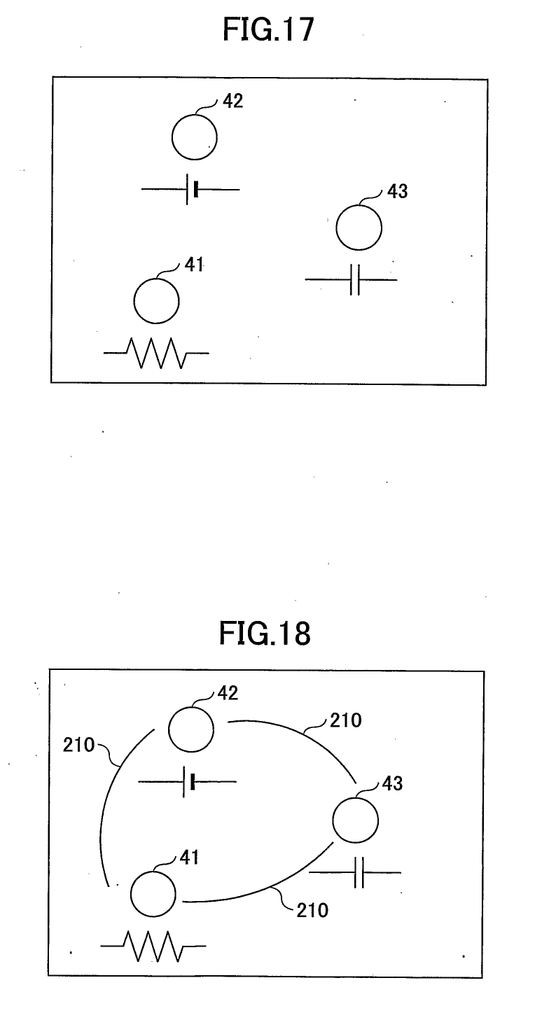

The user first arranges the objects 41 to 43 on given positions on the screen 11. FIG. 17 shows the objects 41 to 43 arranged on the screen 11. When the CCD camera 14 photographs the screen 11, the image extracting unit 21 identifies areas of the objects 41 to 43 and the objects 41 to 43.

Based on the identification information of the objects 41 to 43 transmitted from the image extracting unit 21, the application 24a recognizes the object IDs and each position and causes the projection image forming unit 24 to display images of symbols representing a resistor, a battery, and a capacitor. Thus, on the screen 11, as shown in FIG. 17, the objects 41 to 43 are arranged and the symbols for representing the resistor, battery, and capacitor are displayed.

Further, as shown in FIG. 18, when the user draws the line segments 210 between the object 41, the object 42, and the object 43 using a marker, for example, the CCD camera 14 photographs the screen 11 at predetermined intervals and the figure recognizing unit 26 recognizes each coordinates of the end points of the line segments 210.

The operation processing unit 23 calculates the distance between the end point of the line segment 210 and the central coordinates of the object as shown in FIG. 14. When the distance is not more than a predetermined number of pixels, the object is determined to exist at the end point of the line segment 210 and it is recognized that the objects 41 and 42, objects 42 and 43, and objects 43 and 41 are connected. In other words, each object having attribute information is connected.

Since the objects correspond to elements of an electric circuit, a circuit is assumed to be configured as a result. Upon receiving information that the objects are connected, the application 24a generates an object image for displaying a resistor, power source, capacitor, and the like. Also, the application 24a refers to predetermined rules (physical law such as electric law), calculates computable physical quantity such as voltage on each element and the like based on the circuit where the resistor, power source, and capacitor are connected, and generates an image for displaying the calculation result.

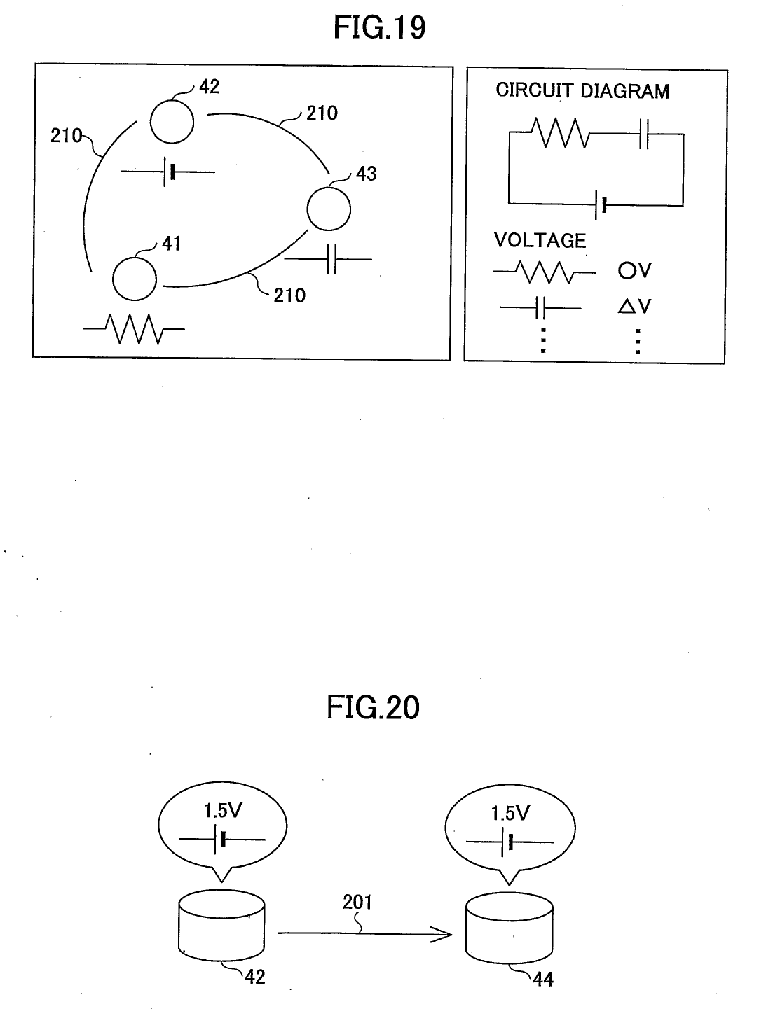

FIG. 19 shows an example of the circuit diagram displayed on the screen 11 by the application 24a. The circuit diagram may be displayed on a sub-screen disposed along with the screen 11, or may be displayed on a portion of the screen 11. In FIG. 19, resistance and voltage applied to the capacitor are calculated and displayed below the circuit diagram. Although the circuit diagram is shown in FIG. 19 since the identification information of the object concerns an electric circuit, the application 24a may perform various simulations, namely, molecular structures, structures such as buildings, distribution of an electromagnetic field, DNA structures, and the like in accordance with the identification information of the object. Also, when characters are manually written or voice inputting is performed, various simulations may be performed depending on contents recognized via OCR or voice recognition.

In addition, when only the objects 41 and 42 are linked using the line segment 210, the circuit is recognized as having only a battery and a resistor and voltage applied to the resistor is calculated. In this manner, the objects are linked using a drawn line segment, operability is improved in the present example.

Next, the definition of identification information is described. When the user arranges the objects 41 to 43, performs handwriting, or the like on the screen 11, if objects defined in advance (battery elements, for example) are insufficient, objects with undefined attributes are defined as having desired attributes.

FIG. 20 shows an example of a hand-drawn figure for defining attributes of a desired object to other object. A method for defining attributes may be any method. For example, a single-headed arrow 201 is manually drawn, the object 42 (battery) is disposed at a start point of the single-headed arrow 201 and the object 44 with undefined attributes is disposed at an end point of the single-headed arrow 201. When the definition of the attributes is finished, the operation processing unit 23 operates the projection image forming unit 24 such that balloons for the objects 44 and 42 are created so as to display the thus set identification information, whereby the user is capable of recognizing that the attributes are defined.

The operation processing unit 23 defines the attribute information of the object 42 disposed at the start point of the single-headed arrow 201 in an attribute information storing unit 25 as the attribute information of the object 44 disposed at the end point of the single-headed arrow 201. Thereafter, the application 24a recognizes the object 44 as a 1.5V battery. In this manner, operability for the user is improved by duplicating the attribute information between objects using the hand-drawn single-headed arrow.

In the same manner, it is possible to define attributes in other objects 45 to 47. As an example, the object 45 is defined as a battery, the object 46 as a resistor, and the object 47 as a capacitor. Thus, the attribute information of the objects 41 to 47 are as follows.

Object 41: resistor

Object 42: battery

Object 43: capacitor

Object 44: battery

Object 45: battery

Object 46: resistor

Object 47: capacitor

When the attribute information is defined at random as in this case, the object ID and the attribute information are randomly defined, so that it is not appropriate for the user to handle. In view of this, a method for managing batteries, capacitors, and resistors with successive object IDs is described.

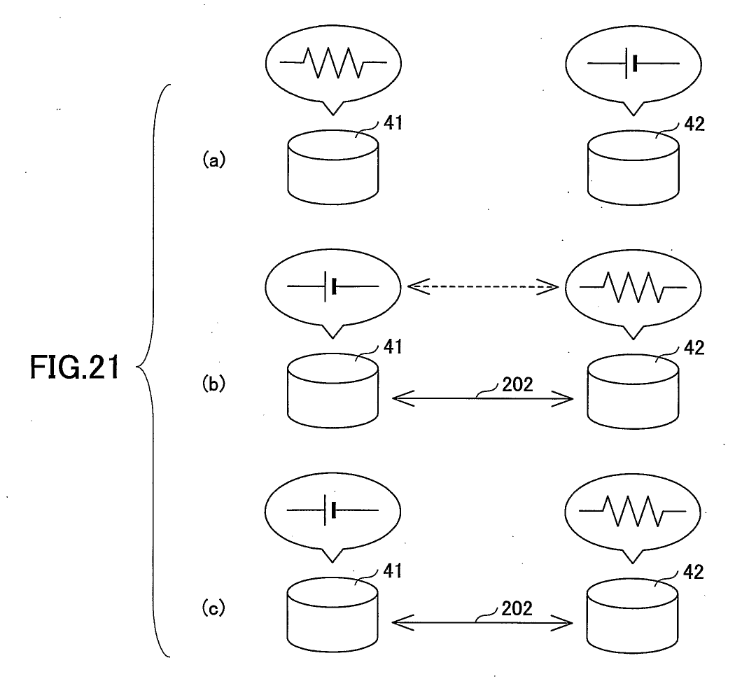

FIG. 21 shows an example of a hand-drawn figure by which attribute information of objects is switched for redefinition. In order to switch the attribute information, objects whose attribute information is to be switched are disposed at end points of a double-headed arrow 202. Thus, as shown in FIG. 21-(a), when the object 41 and 42 are disposed at the end points of the double-headed arrow 202, the operation processing unit 23 defines the object 41 as a battery and the object 42 as a resistor as shown in FIG. 21-(b) and updates the attribute information storing unit 25.

Based on the same operation, by switching and determining the object 42 to the object 44, the object 43 to the object 45, and the object 45 to the object 46, the same attribute information is defined as follows in the successive object IDs. The attribute information can be switched between the objects using the hand-drawn double-headed arrow, so that the managing form of the objects by the user is improved.

Objects 41, 42, and 43: batteries

Objects 44 and 45: resistors

Objects 46 and 47: capacitors

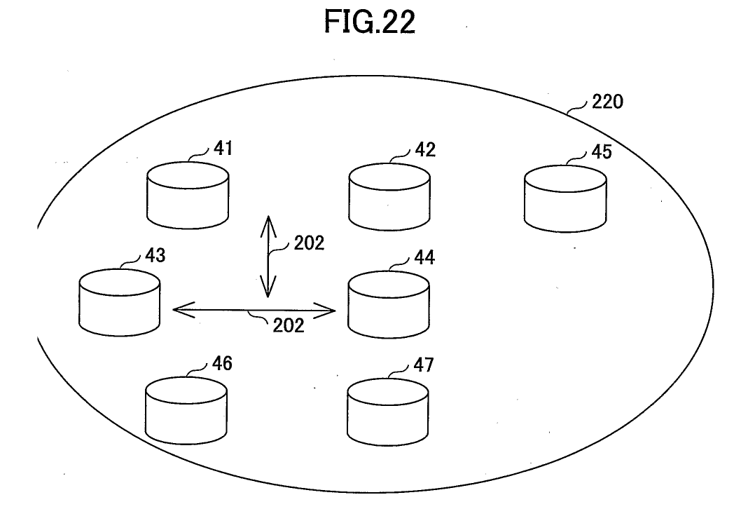

In addition, instead of performing plural operations in order to define the same attribute information in the successive object IDs, the redefinition may be performed using a single hand-drawn figure. FIG. 22 shows an example of a hand-drawn figure for defining (sorting) the same attribute information in the successive object IDs. When the user arranges objects to be redefined, surrounds the objects with a closed loop 220, and manually draws the double-headed arrows 202 in the horizontal and vertical directions, the operation processing unit 23 redefines the same identification information in ascending or descending order of the object IDs.

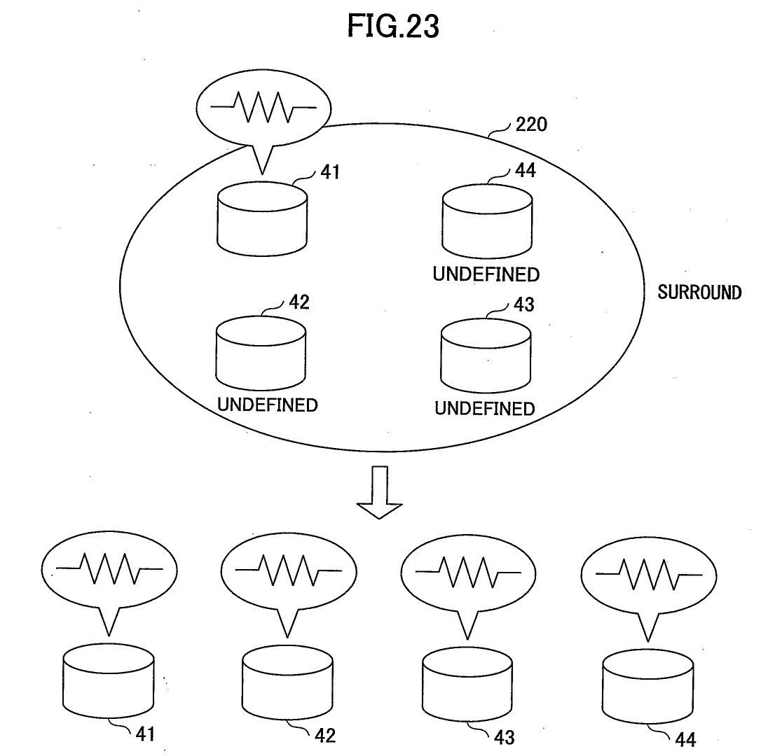

Further, it is possible to define plural objects with the same attribute information at one time. FIG. 23 shows an example of a hand-drawn figure for defining the same attribute information in the plural objects at one time. When the user arranges an object whose attribute information is to be duplicated and plural objects with undefined attributes, and surrounds the objects with a closed loop 220, the plural objects are defined as having the same attributes without complicated operations. It is possible to collectively manage the attribute information of the objects within the closed loop, so that operability is improved.

Moreover, when the user is capable of defining the attributes of the objects in this manner, there are cases where the redefinition is repeated by the aforementioned operation or other user uses the displaying apparatus. Thus, it is preferable to prepare in advance a method for confirming how the identification information of the objects is currently defined.

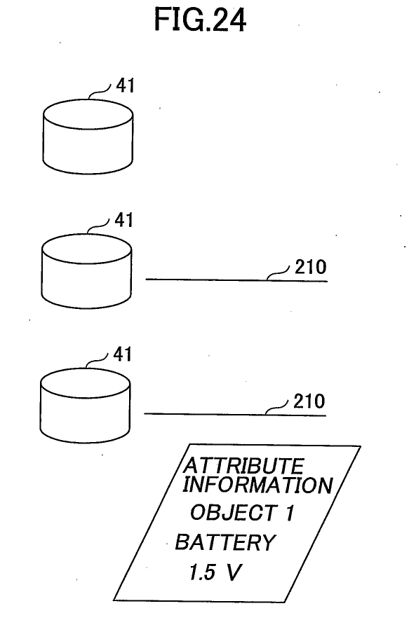

FIG. 24 shows an example of a hand-drawn figure for examining the attribute information of the object. The user arranges an object whose identification information is to be examined and draws a line segment (such as a lead line used in design drawing). Upon drawing the line segment in this manner, the operation processing unit 23 extracts the attribute information of the object 41 from the attribute information storing unit 25 and operates the projection image forming unit 24 such that an image for displaying the attribute information of the object is generated in the vicinity of other end point of the line segment, for example. Whether the line segment is for examining attribute information or connection can be determined by the presence or absence of objects disposed at both ends of the line segment. By drawing the line segment, the attribute information of the object can be browsed, so that the management and operability of the object are improved.

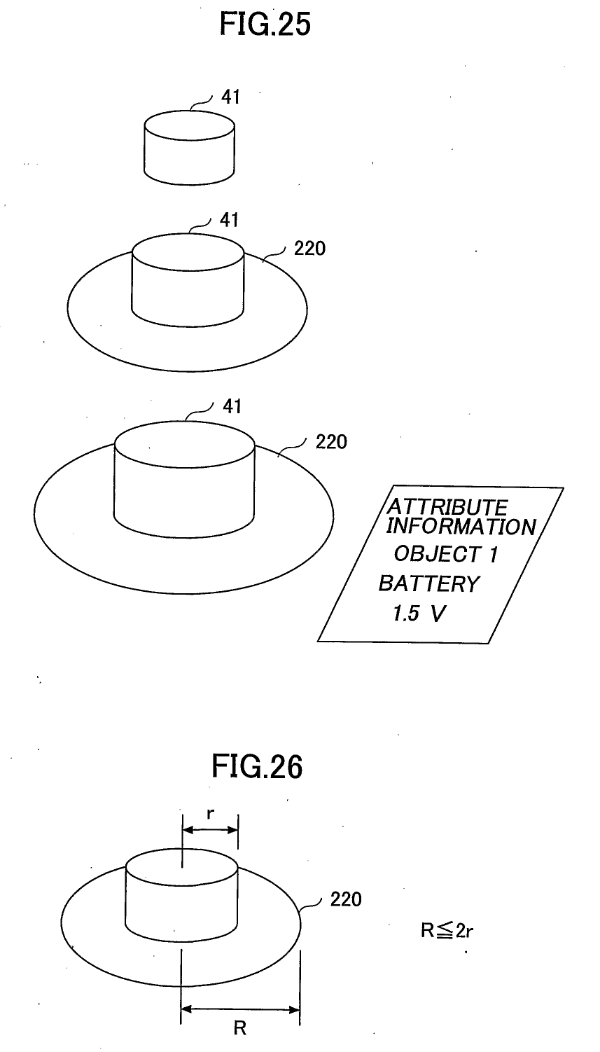

In addition, the aforementioned hand drawing and the arrangement position of the object are a mere example. Thus, when examining the attribute information of the object, the object may be disposed and the closed loop 220 for surrounding the object may be drawn. FIG. 25 shows an example of a hand-drawn figure in which the closed loop 220 for surrounding the object is drawn and the attribute information of the object is examined. When a single object is surrounded by the closed loop 220, the operation processing unit 23 extracts the attribute information of the object 41 from the attribute information storing unit 25 and operates the projection image forming unit 24 such that an image for displaying the attribute information of the object is generated in the vicinity of other end point of the line segment, for example. By drawing the closed loop, the attribute information of the object can be browsed, so that the management and operability of the object are improved.

In the following, description is given regarding a case where there are no undefined objects through repetition of various operations and a given object is returned to an undefined status. FIG. 26 shows an example of hand drawing for returning the object to the undefined status again. For example, the object is disposed and a circle with a radius R not more than twice the radius r of the object is drawn so as to surround the object (R≦2r). In accordance with this, the operation processing unit 23 recognizes the object as independent of other objects, namely, undefined and eliminates the attribute information of the object in the attribute information storing unit 25. In this manner, by using the size of the circle as the parameters of a hand-drawn figure, it is possible to deal with the same closed loop for other operation.

In addition, the circle for eliminating the attribute information having not more than twice the size of the object may be a circle of other size such as a circle not more than three times, and it is possible to surround the object with a quadrangle or a triangle.

Further, the object surrounded by the closed loop 220 as mentioned above may be defined such that the attribute information cannot be redefined thereafter. In accordance with this, for example, by surrounding an object storing attribute information with the closed loop 220, the attribute information being used as basic information not to be eliminated, it is possible to prevent the elimination of the attribute information as basic information. The object defined as non-definable has definition permission “disabled” in the attribute information storing unit 25. Since the object surrounded by the closed loop can be dealt with as an independent object, the operability thereof is improved.

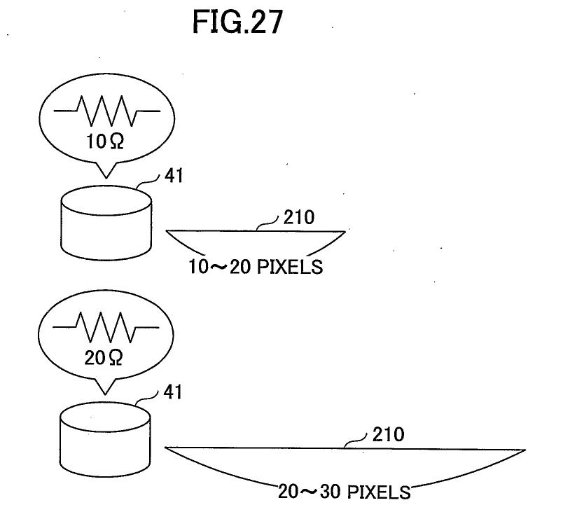

In the case of an application for circuit simulation as in the present embodiment, each object is defined as the resistor, battery, or capacitor. In the circuit, it is necessary to change capacity of each element and voltage. When the capacity and voltage are changed, the capacity and voltage are defined in accordance with the length of a line segment from the object. FIG. 27 shows an example of a hand-drawn figure for defining capacity and voltage in accordance with the length of the line segment. For example, the operation processing unit 23 defines attribute numerical values in the attribute information storing unit 25, namely, 10Ω for 10 to 20 pixels and 20Ω for 20 to 30 pixels. The attribute information of the object can be edited/defined in accordance with the length of the line segment, so that flexible definition is possible depending on environments.

In addition, the relationships between the length of the line segment and numeral values to be defined is preferably determined such that appropriate values are set where necessary in accordance with the resolution of the projection plane, the resolution of the camera, and operability. Whether the line segment is for displaying attributes or for changing attribute numerical values can be determined by switching mode setting of the application 24a or drawing a figure at an end of the line segment where the object is not disposed. Moreover, other type of line may be used.

When line segments are drawn between objects as mentioned above, the operation processing unit 23 recognizes that the objects are connected. For example, when the objects 41, 42, and 43 are arranged and line segments are drawn between the objects 41 and 42, 42 and 43, and 43 and 41, the operation processing unit 23 recognizes that the objects 41, 42, and 43, namely, the battery, resistor, and capacitor are connected.

Although the capacity of power source of the battery is defined as constant 1.5V or fixed but variable attribute numerical values, it is possible to change the attribute numerical values of the object such as the capacity of power source to a given value in accordance with position information and attachment/detachment of the object. The position information includes a two-dimensional position, object rotation, movement speed, and rotation speed. The attachment/detachment is performed by detaching the object from the drawing plane 11b and disposing it again.

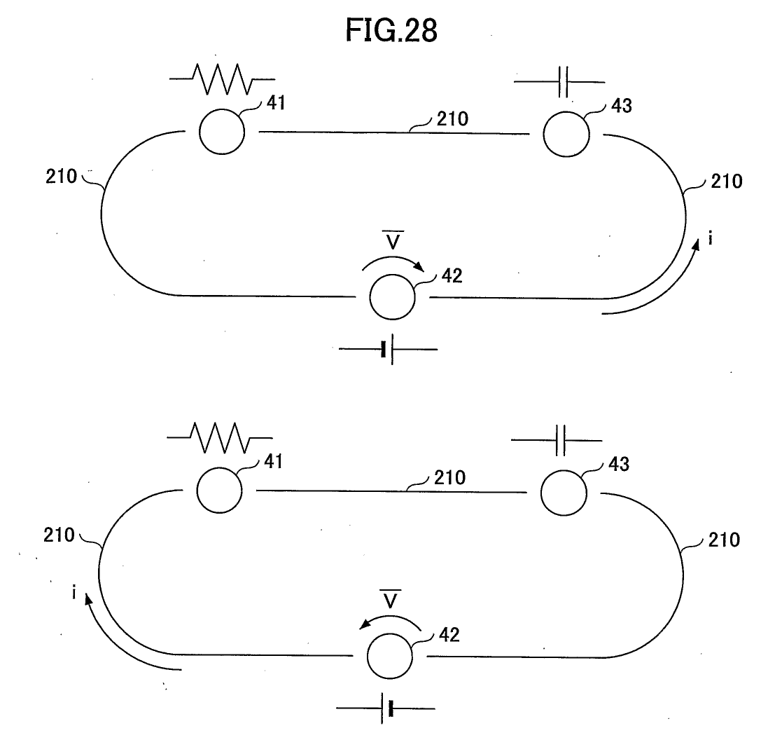

When the attribute numerical values are changed, for example, the change is determined by at least one of the rotation direction and an angle of the object. FIG. 28 shows an example of a hand-drawn figure for changing attribute numerical values. In accordance with line segments between the objects 41, 42, and 43, the application 24a recognizes that these objects are connected. Thereafter, for example, when the user operates the object 42 to rotate in the counterclockwise direction, the operation processing unit 23 detects the rotation of the object as will be described in the following, and the application 24a calculates a voltage value and the like in each element on the assumption that a current is flown in the counterclockwise direction. By contrast, when the user operates the object 42 to rotate in the clockwise direction, the application 24a recognizes that the current is flown in the circuit in the clockwise direction and calculates the voltage value and the like. By defining a positive or negative current in the clockwise or counterclockwise direction, positive or negative voltage value is determined and the current direction is also determined. The attribute information of the object can be edited/defined in accordance with the rotation direction or the angle of the object, so that intuitiveness is enhanced and operability is improved.

In the following, description is given regarding a method for detecting operations based on the rotation of the object. For example, when a frame rate of the camera is 7.5 fps, rotation is recognized if an identification pattern image of the bottom of the object is rotated by not less than 90 degrees in about 2 seconds after finishing the drawing of a line segment, namely, in 15 time-series images.

In the 15 images, when the voltage value is gradually increased (by 0.5V, for example) by 10 degrees starting from 90 degrees, it is possible to arbitrarily set the current direction and voltage value in accordance with the rotation operation of the object after the line segment is drawn and the object is disposed. Regarding the rotation angle, time to decide the direction, and procedure of setting the angle, smooth operations are possible by setting appropriate values taking into consideration the frame rate of the camera and operability on the application.

In the method for determining the rotation direction and rotation angle, direction in each image can be readily identified through matching using a template in which the directions of rotation are registered in the dictionary in advance.

In FIG. 28, the objects are connected with the line segments. However, the plural objects may be surrounded by a closed loop and the attribute numerical values may be changed thereafter when the rotation of the object is detected.

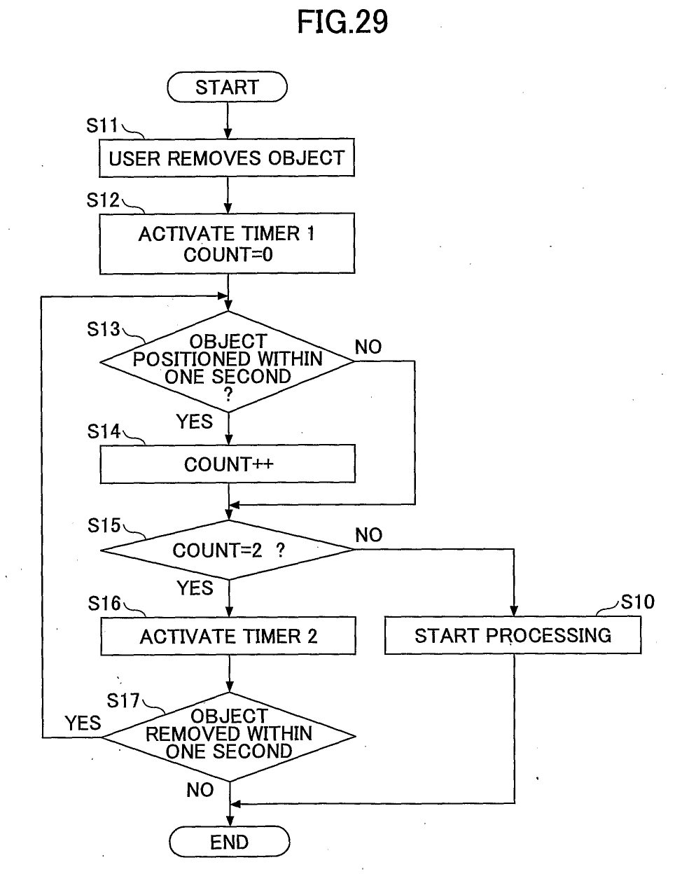

Next, description is given regarding a method for detecting an operation based on an attachment/detachment operation of an object with reference to a flowchart of FIG. 29. In the flowchart of FIG. 29, a predetermined processing is performed determining whether the object is attached and detached twice in a predetermined time, which corresponds to double-clicking of a computer.

When the user arranges the objects, draws the line segments, and each object is connected, the application 24a recognizes that a circuit diagram is crated. The application 24a is in a standby status at this stage without calculating voltage value in each element.

When the user raises the object (S11), an image of the object ceases to be detected at a position where the object was disposed. When the image of the object is not detected, an operation of a timer 1 is started (S12). The operation processing unit 23 sets 0 in a count of a counter for indicating the number of detachment/attachment.

When the count of the counter is set to 0, the application 24a monitors whether the object with the same attribute information is disposed on the position again where the object was disposed in a predetermined time (within one second, for example) (S13). The position where the object was disposed may be determined by detecting whether the object is disposed within a predetermined distance from the end point of the line segment drawn by the user.

When the object with the same attribute information is disposed, the application 24a increments the count by one to set 1 in the count (S14).

Next, whether the count is 2 is determined (S15). If the count is 2, processing set in accordance with detachment/attachment as will be described in the following is performed (S10).

If the count is not 2, an operation of a timer 2 is started (S16). Time of the operation of the timer 2 may be a time when the object is disposed, for example. The timer 2 is operated when the object is disposed after a predetermined time or the object is not disposed. If the object is not disposed, the timer 1 is monitored so as to determine timeout when the predetermine time or more has elapsed and processing of the flowchart of FIG. 29 is repeated from the start.

Next, the application 24a monitors whether the object disposed within the predetermined time (one second, for example) is removed based on the timer 2 (S17).

If the object is removed in the predetermined time, the process returns to step S3 and monitors whether the object with the same attribute information is disposed (S13). If the object is disposed in the predetermined time, the count is incremented by one (S14). Thus, when the object is detached and attached twice in the predetermined time, the count is 2.

If the count is 2 (S15), processing is started as detachment/attachment is conducted twice in the predetermined time (S10). The processing performed in step S10 may be defined arbitrarily. For example, the application 24a calculates voltage value and the like in each element.

As mentioned above, user operations can be determined on the basis of the detachment/attachment of the object as if to determine by double-clicking on a mouse. The predetermined time being set varies in accordance with the frame rate of the camera and operability of the application, so that it is preferable to appropriately set the predetermined time where necessary. Also, the number of the detachment/attachment is set in the same manner and it is possible to change processing depending on the difference of the number. In accordance with the number of the detachment/attachment of the object, it is possible to change operations depending on figure types, thereby improving operability.

Although the flowchart of FIG. 29 describes the case where objects are connected using line segments, plural objects may be surrounded by a closed loop and user operations may be determined when the detachment/attachment of the object is detected.

Although the above describes the case where user operations are detected while drawing by the user is drawn on the drawing plane 11b, when attribute information is defined in an undefined object or the attribute information is duplicated or switched, even if the drawn figure such as an arrow is erased, objects whose attribute information is redefined preferably and generally store definition information thereof. Thus, in the present example, the attribute information of the object is maintained even when the drawing such as an arrow is erased. In addition, when the user is changed or the application 24a is to reload other application, it is possible for plural users or other application to use the same objects without causing trouble to the user when the operation processing unit 23 eliminates the attribute information in the attribute information storing unit 25.

Regarding the objects as well as drawn figures, when the object is removed from the screen 11, the defined attribute information, the circuit configuration detected in accordance with the attribute information of the object, and the like are maintained in the same manner. Thus, for example, when the object is moved, the defined attribute information, the circuit configuration detected in accordance with the attribute information of the object, and the like stored. The movement of the object refers to a case where the object is detected again in an area of the end point of the line segment or an area of the closed loop in A to B seconds, for example. The removal refers to a case where the object is not detected after B seconds has elapsed.

Whether the defined attribute information and the circuit configuration detected in accordance with the attribute information of the object is maintained is a design matter, so that when the drawn figure is erased or the object is removed or moved, the defined attribute information, the circuit configuration detected in accordance with the attribute information of the object, and the like may be eliminated.

As mentioned above, by detecting the object and figure drawn by the user and performing the editing/redefinition of the attribute information of the object based on the figure, it is possible to realize more flexible human computer interaction.

### EXAMPLE 2

In the present embodiment, description is given regarding an image display apparatus for simulating winds blowing through buildings in a city, for example. When an object for representing a wind is disposed and a figure for indicating a wind direction is drawn on the screen 11, the application 24a is capable of recognizing that wind simulation is conducted on the screen 11.

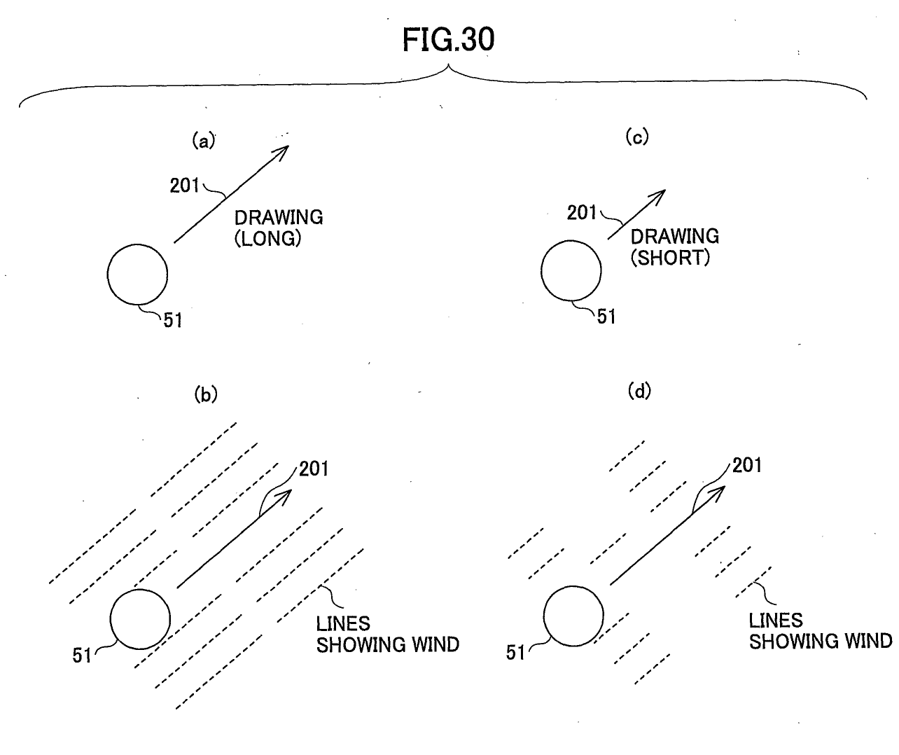

FIG. 30 shows an example of an object to be disposed and a figure to be drawn on the screen 11 for the wind simulation. FIG. 30-(a) shows a diagram in which an object 51 is disposed by the user and the single-headed arrow 201 is drawn from the object 51 in a predetermined range.

The attribute information of the object 51 is defined in the attribute information storing unit 25 and the application 24a recognizes that an object for representing a wind is disposed when the object 51 is detected on the screen. The operation processing unit 23 detects the figure of the single-headed arrow 201 within the predetermined distance from the object 51, so that the application 24a recognizes that air is flown in the direction of the single-headed arrow 201. The application 24a generates an image for indicating an air flow and transmits the image to the projection image forming unit 24, and the image indicating an air flow is projected on the screen 11 from the projector. FIG. 30-(b) shows an example of the object 51 and the image for indicating an air flow projected in accordance with the drawing.

The intensity of an air flow can be adjusted in accordance with the length of the single-headed arrow 201. As shown in FIG. 30-(c), if the single-headed arrow 201 is long, the application 24a generates an image for indicating a strong air flow in accordance with the length. The application 24a prolongs flow lines of the wind or thickens the lines and projects the line of flow on the screen 11 as shown in FIG. 30-(d).

In addition, objects may be defined as having attribute information such as a low pressure system, high pressure system, typhoon, seasonal rain front, and the like and these objects may be arranged on the screen 11 so as to simulate meteorological conditions.

According to the present example, it is possible to define the directions and intensity of winds and simulate winds by merely arranging the objects and simple drawing. Also, the directions and intensity of winds can be readily redefined by only changing the direction and length of the single-headed arrow, so that it is possible to define attribute information in accordance with environments and usage situations.

### EXAMPLE 3

In the aforementioned description, when the object is disposed without specifying where the object is to be disposed on the screen 11, the application 24a recognizes operations in accordance with attribute information determined in advance or the definition of the figure. In the present example, description is given regarding an image displaying apparatus in which the attribute information of the object is enabled in a closed loop determined by the user.

### [If the Closed Loop is Drawn in Advance]

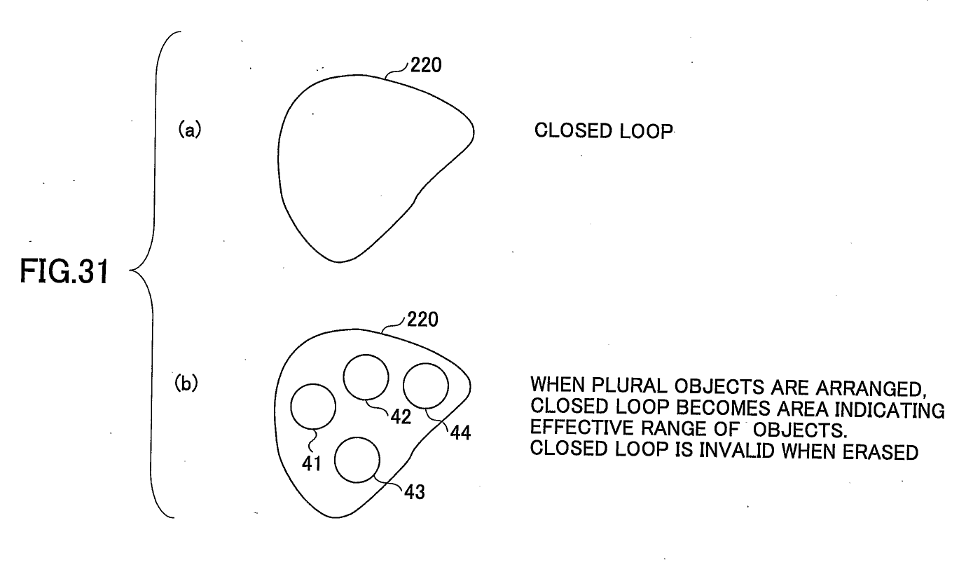

FIG. 31-(a) shows an example of the closed loop drawn by the user. In the present example, attribute information defined in the objects is enabled only in the closed loop. As shown in FIG. 31-(b), when the user arranges the objects 41 to 44 in the closed loop, the application 24a starts a predetermined simulation and the like based on the attribute information defined in the objects 41 to 44.

The operation processing unit 23 operates the projection image forming unit 24 such that a figure image of the closed loop is generated based on figure information of the closed loop. Thus, the figure image of the closed loop is projected such that it is superimposed on the closed loop manually drawn on the projection plane 11a.

Further, since the closed loop enables the attribute information defined in the object, the attribute information is disabled when the closed loop is erased. And the figure image of the closed loop is also erased.

According to the present example, it is possible for the user to set a desired range and determine an area where operations are enabled through the object or the figure drawing. Thus, for example, it is not necessary to set the area where operations are enabled through the object or the figure drawing from a setting screen of software (window or dialog area), mouse, or keyboard. Further, it is possible to divide the screen 11 using the closed loop and conduct plural simulations.

### [If Objects are Arranged in Advance]

Although the closed loop is drawn in advance and then the objects are arranged within the closed loop in FIG. 31, it is also possible to determine the area where operations are enabled through the objects or the figure drawing when the objects are arranged in advance and then the closed loop is drawn.

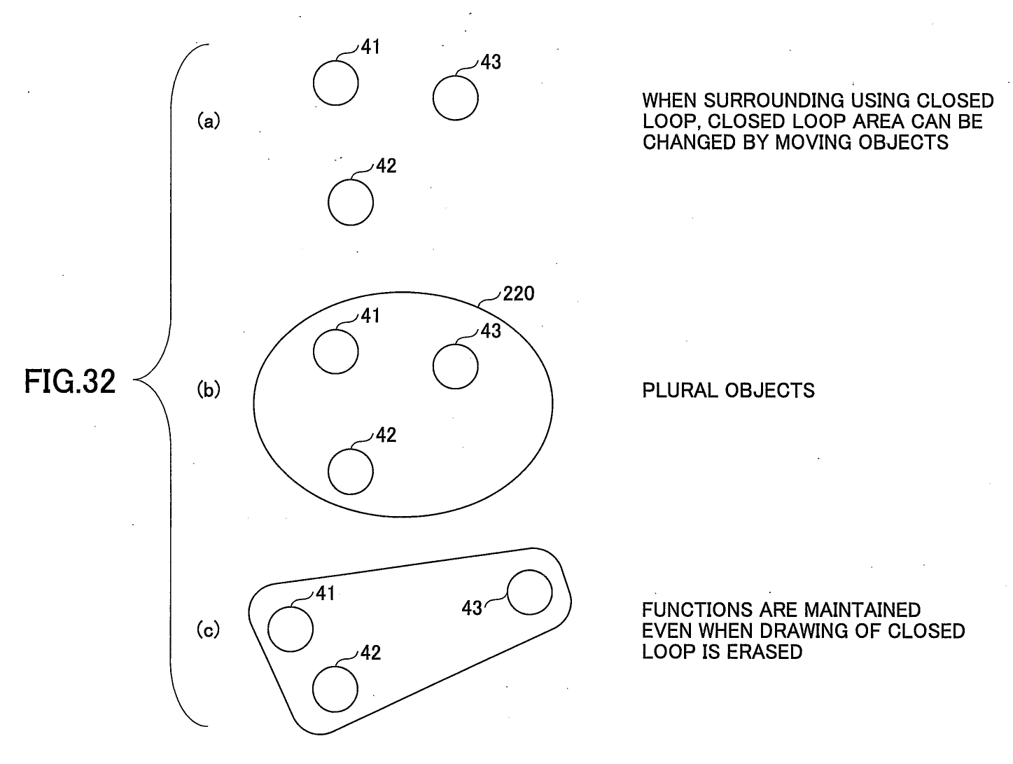

FIG. 32-(a) shows plural objects arranged by the user and FIG. 32-(b) shows the drawing of a closed loop surrounding the objects. By surrounding the objects 41 to 43 by the closed loop, attribute information defined in the objects is enabled only in the closed loop. When the user surrounds the objects 41 to 43 by the closed loop, the application 24a starts a predetermined simulation and the like based on the attribute information defined in the objects 41 to 43.

Since the attribute information is enabled by the positions of the objects and the closed loop, when the objects are moved, the area where the attribute information is enabled is also changed as shown in FIG. 32-(c). In this case, the operation processing unit 23 operates the projection image forming unit 24 such that a figure image of the closed loop surrounding the moved objects is newly generated based on stored figure information of the closed loop. Further, even when the hand-drawn closed loop is erased, the figure information of the closed loop is stored, so that the generated figure image is not eliminated.

Since the attribute information is enabled in the range where the objects are arranged, even when the closed loop is erased, the attribute information defined in the objects is not disabled.

[If Effects are Different Between the Case where the Objects are Arranged in Advance and the Case where the Closed Loop is Drawn in Advance]

Operations performed by the application 24a may be changed between the case where the figure is drawn in advance and then the objects are arranged and the case where the objects are arranged in advance and then the figure is drawn.

For example, when the figure is drawn in advance and then the objects are disposed, the application 24a performs an operation A and when the objects are disposed in advance and then the figure is drawn, the application 24a performs an operation B.

When the closed loop is drawn and then plural objects are arranged in the closed loop, the attribute information of the objects is enabled only in the closed loop (operation A). When the closed loop is drawn so as to surround objects having certain attribute information and plural objects whose attribute information is undefined, the plural objects in the closed loop are defined in the attribute information storing unit 25 as having the same attribute information (operation B). Thus, although plural objects are arranged in the closed loop in both cases, it is possible to discriminate operations depending on whether the objects are arranged in advance or the closed loop is drawn in advance.

### EXAMPLE 4

In examples 1 to 3, description is given regarding the methods for defining and redefining the attribute information about objects and for defining attribute numeral values thereof based on the types of obtained figures and sizes thereof. In the present example, description is given regarding an image displaying apparatus in which a figure image for displaying a figure based on the attribute information of objects is generated.

FIG. 33 is an example of the attribute information storing unit 25 according to the present example. In the present example, attribute information is stored as information for specifying the contents of a figure image, such as solid lines, dotted lines, filling, erasing, and the like. Thus, it is possible to operate or erase line types of a figure depending on an object to be disposed.

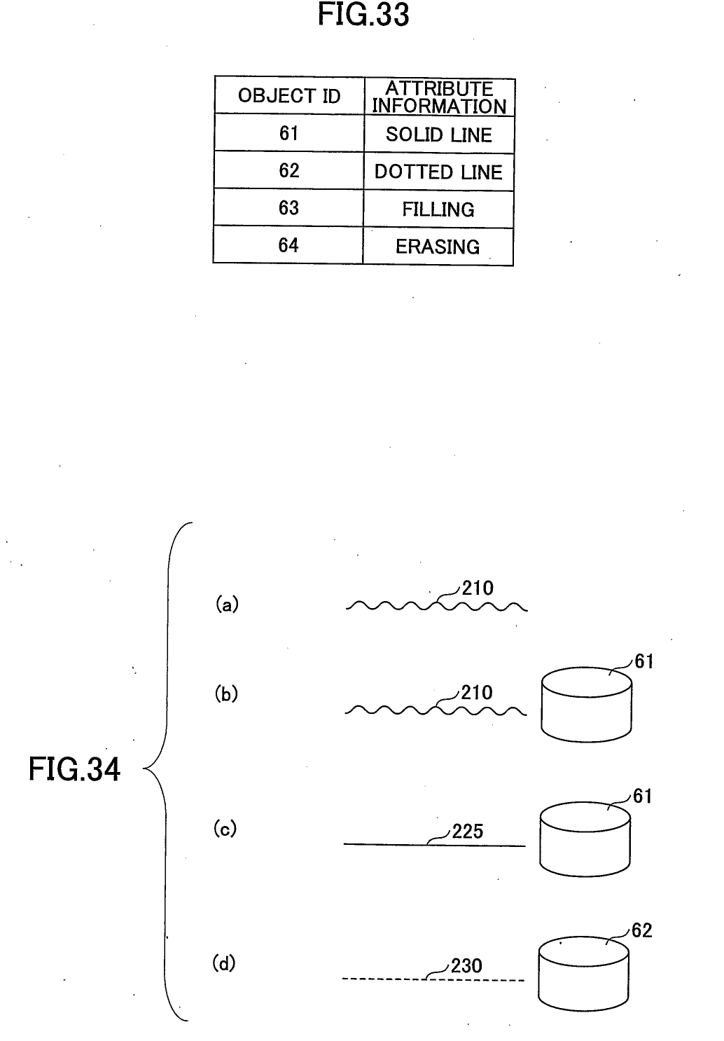

It is assumed that an object 61 having attribute information of a solid line and an object 62 having attribute information of a dotted line are provided. The user draws a line segment of a given form on the drawing plane 11b and disposes the object 61 on the end point of the line segment. FIG. 34-(a) shows the line segment of a given form drawn on the drawing plane 11b. The object recognizing unit 22 extracts the figure of the line segment 210 from imaging data photographed using the CCD camera 14.

When the user disposes the object 61 on the end point of the line segment 210 as shown in FIG. 34-(b), the object recognizing unit 22 obtains the identification information about the object 61, and then the operation processing unit 23 extracts the attribute information (solid line) about the object 61 from the attribute information storing unit 25. The operation processing unit 23 operates the projection image forming unit 24 such that a figure image of a solid line 225 is superimposed on the line segment manually drawn by the user.

FIG. 34-(c) shows an example of the image of the solid line (figure image) 225 displayed by the projector 13 from the projection image forming unit 24. In FIG. 34-(c), the line segment manually drawn by the user is omitted.

Further, when the object 62 is disposed on the end point of the line segment manually drawn by the user or on the end point of the line segment projected from the projection image forming unit 24, the operation processing unit 23 extracts the attribute information (solid line) about the object 62 from the attribute information storing unit 25 and displays a line segment as a figure image of a dotted line 230 as shown in FIG. 34-(d).

If the same figure drawing is performed on a computer, operations for drawing the line segment 210 and selecting and changing line types from a menu or command buttons are required. Thus, it is necessary to search for the location of the command or the menu for performing the operation. Such complexity cannot be eliminated in mouse operations or touch panel operations.

By contrast, when the same operations are possible by merely disposing the object having predetermined attribute information defined as in the present example, the user is capable of intuitively performing the operations, so that operability is improved.

Further, in the present example, even when the closed loop is manually drawn and the object is disposed in the closed loop in addition to the line segment drawing, it is possible to generate and display an image in which the line types of the drawn closed loop are changed or the closed loop is filled based on the attribute information of the object determined in advance.

When the attribute information of the object is applied to the manually drawn figure, the display of the projected line segment may be ended by removing the object or the projection may be continued. In addition, when the object is moved, the attribute information thereof (line types, for example) may be maintained or eliminated.

Next, description is given regarding a case where an image projected in accordance with the attribute information about the object is cancelled. An object 63 is assumed to have attribute information for filling and the object 63 is disposed in the manually drawn closed loop.

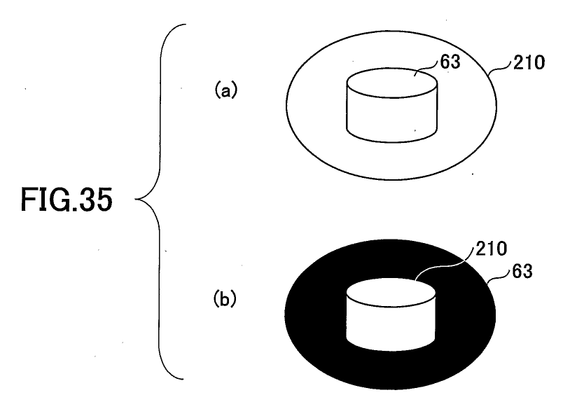

FIG. 35-(a) shows the object 63 disposed in the closed loop. The figure recognizing unit 26 recognizes the closed loop figure and the object recognizing unit 22 obtains the identification information about the object 63. The operation processing unit 23 extracts the identification information (for filling) about the object 63 and operates the projection image forming unit 24 such that the image of the closed loop figure is filled in one color as shown in FIG. 35-(b).

If the object has attribute information for filling as in the object 63, attributes depending on rotation is preferably defined. For example, if a rotation angle is not more than 30 degrees in a predetermined time (five frames, for example), a filling color can be changed by rotating the object 63. If the rotation angle is more than 30 degrees in the predetermined time, the closed loop is filled by the previous color, for example, as the filling color is selected.

If the rotation more than 30 degrees cannot be detected after the predetermined time has elapsed, the color is changed and the filling is not performed. If the object 63 is removed, the status thereof returns to one before the closed loop is filled based on the attribute information of the object, namely, a drawn status.

A rotation direction and the detection of angle information is the same as described in example 1. It is possible to change, determine, and cancel attributes in accordance with the rotation direction and the angle of the object, so that an intuitive operation method can be realized.

By using the method as mentioned above, the operability of filling is improved. If the same operations are to be performed by software, it is necessary to perform operations for selecting a cancellation command and a determination command through mouse operations after the filling is performed, for example, and if the user does not know such an operation method, the filling cannot be cancelled. In the present example, the filling is performed by disposing the object 63 and the cancellation thereof can be performed by merely rotating the object, so that the cancellation of filling and the color change can be easily made.

Further, the setting and cancellation of a filling color may be performed through detachment/attachment in a predetermined time as described in the flowchart in FIG. 29. Such operations include one detachment/attachment for changing colors and two detachment/attachments for cancellation of filling, for example.

The filling may be cancelled also by using an object for cancellation. In this case, the object having attribute information for filling cancellation is selected and disposed.

When a drawn figure is erased, display by the projection image forming unit 24 may also be eliminated or an object for elimination or other operation may be required so as to eliminate the drawing by the projection image forming unit 24. By appropriately setting processing performed by the projection image forming unit 24 in response to the elimination of figure information, high operability can be realized.

As mentioned above, in the image displaying apparatus according to the present embodiment, it is possible to define the attribute information about the object, so that an image displaying apparatus capable of flexible operations can be provided. Further, by drawing the hand-drawn figure along with the object, it is possible to readily perform simulations of an electric circuit, winds, and the like. And by determining the rotation, movement, detachment/attachment, and the like, in addition to object identification, it is possible for the user to flexibly and intuitively perform operations. Moreover, with the use of the object, it is possible to change the line types and colors of the hand-drawn figure and attributes for filling, so that the image can be edited by intuitive operations.

### Second Embodiment

The identification code provided to the bottom of the object used in the first embodiment is formed to have a unique pattern taking into consideration the rotation of the object. However, such identification code has problems in that:

(i) it is necessary to register forms of the identification code in the dictionary in each rotation angle, since code patterns are changed in accordance with the rotation angle of the object,

(ii) the number of identification codes that can be registered is limited, since the identification codes must be unique taking into consideration the rotation of the object, and

(iii) it is necessary to scan the whole area of the object bottom so as to recognize the object.

In view of this, in a second embodiment, a circular one-dimensional barcode (hereafter referred to as a circular barcode) is provided as an identification code of the object and description is given regarding an image displaying apparatus capable of inputting commands based on the identification information or movement of the object. In addition, a schematic diagram of the image displaying apparatus is the same as in FIG. 1 and description thereof is omitted.

### EXAMPLE 5

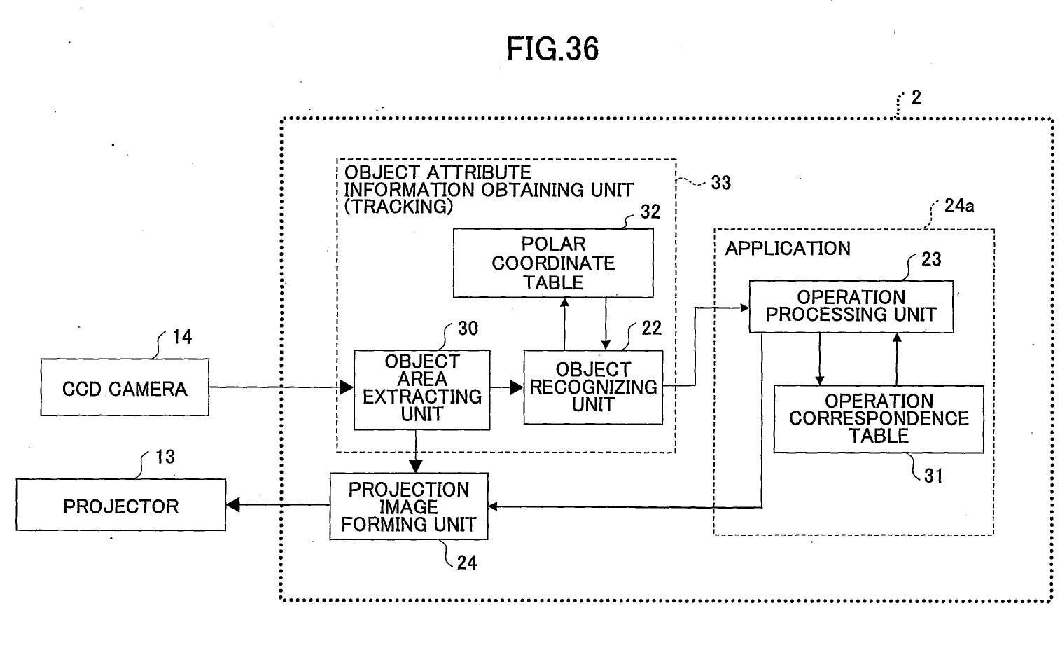

FIG. 36 shows a functional diagram of the image displaying apparatus according to the present embodiment. In FIG. 36, the same components as in FIG. 2 are provided with the same numerals and description thereof is omitted. In an image displaying apparatus 2 of the present example, the CCD camera 14 is connected to an object attribute information obtaining unit 33, and the object attribute information obtaining unit 33 is connected to the application 24a and the projection image forming unit 24.

The object attribute information obtaining unit 33 includes an object area extracting unit 30, a polar coordinate table 32, and the object recognizing unit 22. The application 24a includes the operation processing unit 23 and an operation correspondence table 31.

The object area extracting unit 30 extracts the identification code of the object from image data photographed using the CCD camera 14. The object recognizing unit 22 analyzes the identification (pattern) code extracted by the object area extracting unit 30 and recognizes an ID code and the position of a white portion. The operation correspondence table 31 corresponds to the attribute information storing unit 25 of FIG. 2, where the contents of operation performed by the operation processing unit 23 are recorded in association with ID codes and the like as will be described in the following. In FIG. 36, although the image extracting unit 21 and the figure recognizing unit 26 are not provided, the object area extracting unit 30 includes the functions of the image extracting unit 21 in the present embodiment. The figure recognizing unit 26 is omitted only for ease of description, so that the figure recognizing unit 26 is applied to the object attribute information obtaining unit 33 so as to recognize a hand-drawn figure.

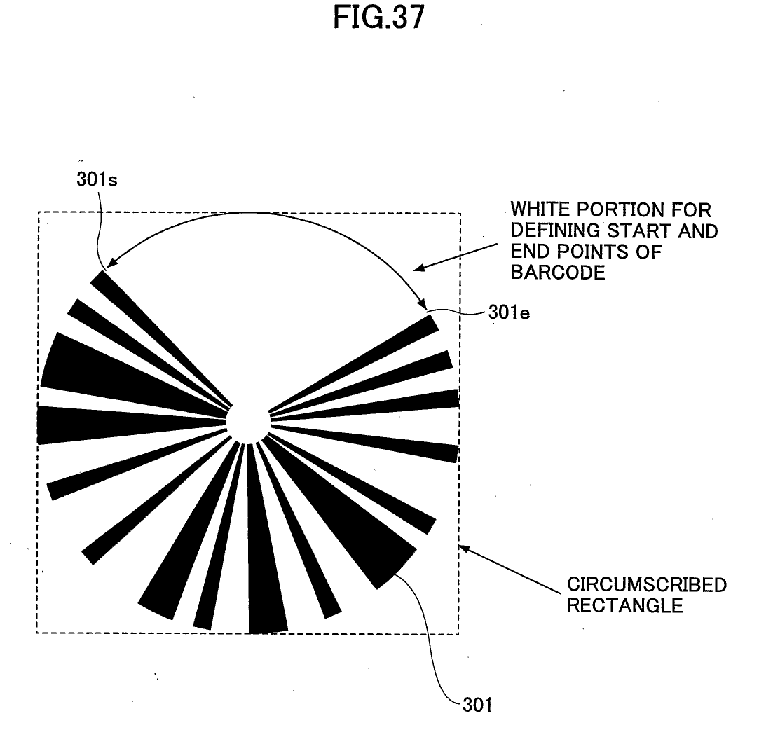

In the following, the identification code according to the present example is described. FIG. 37 shows an example of the identification code (circular barcode) attached to the object. A circular barcode 301 is attached, drawn, or engraved in a predetermined surface of the object or formed using electronic paper, for example.

The circular barcode 301 refers to a barcode in which a one-dimensional barcode is arranged in a circular form having a predetermined point as a center thereof. The one-dimensional barcode is for representing numeral values and the like in accordance with the thickness and space of striped lines. Bars of the circular barcode 301 are arranged in a circular form, so that the thickness of lines and space are increased depending on a distance from the center in a radius direction. In other words, each line of the barcode has a wedge-like form.

The circular barcode 301 is characterized in that a wide white portion is provided for ease of determining a start point 301s and an end point 301e of the barcode and for identifying the direction of the object.

By arranging the circular barcode 301 using a color darker than that of a pen for drawing on the drawing plane 11b, it is possible to identify the position of the object by color depth even when the object is disposed on the drawing plane 11b in which drawing is provided using the pen. In addition, a color identifiable and differing from those colors of a shadow and the pen may be used.

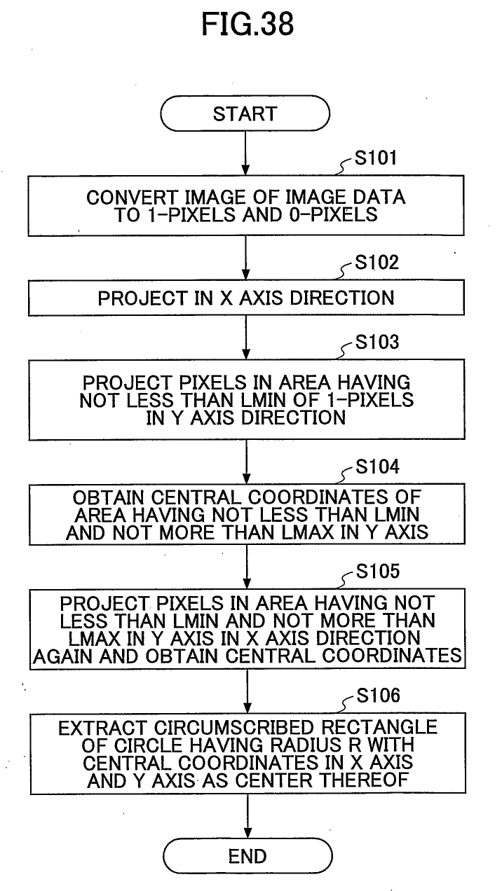

In the following, description is given regarding a processing procedure of the object area extracting unit 30 with reference to a flowchart of FIG. 38.

S101

Image data photographed using the CCD camera 14 is successively transmitted to the object area extracting unit 30. The object area extracting unit 30 obtains RGB information about pixels of the obtained imaging data by pixel, determines a pixel value (from 0 to 255 for each color in the case of RGB) of each pixel with a predetermined threshold value, and handles pixels whose pixel value is not more than a certain threshold value as 1-pixels and pixels more than that value as 0-pixels.

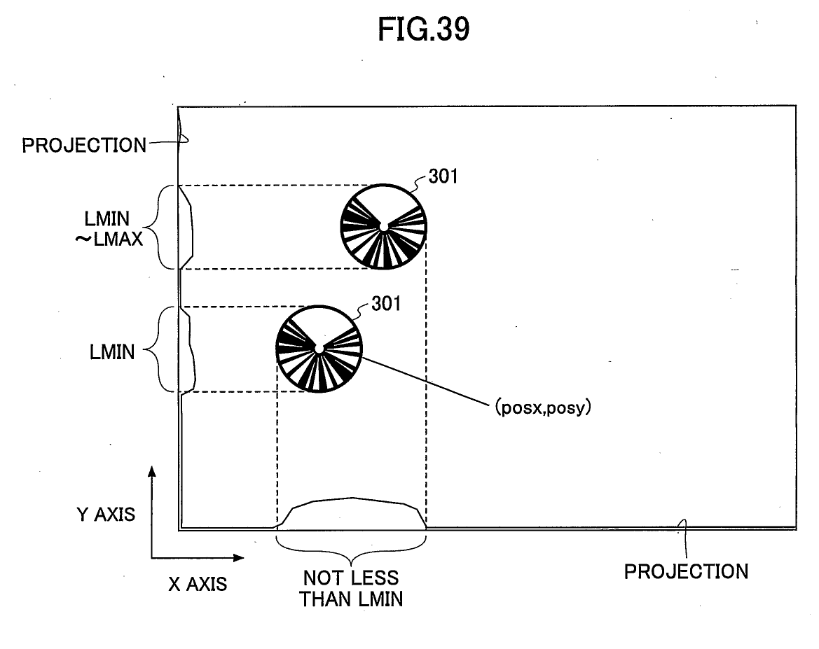

FIG. 39 shows an example of image data on a photographed object in which the image data is converted to 1-pixels and 0-pixels based on the predetermined threshold value.

S102

The object area extracting unit 30 performs raster scanning in each frame of the image data and performs projection in the x axis direction. In accordance with this processing, lines of 1 and 0 pixels are prepared in the x axis direction. As shown in FIG. 39, 1-pixels are arranged in the x axis for an area where the object is disposed.

An area of x coordinates is extracted, in which the successive 1-pixels arranged in the x axis direction exist not less than a predetermined value, namely, Lmin pixels. Then, projection is performed in the y axis direction in the area (all areas in a case of plural areas). As shown in FIG. 39, the 1-pixels are arranged in the y axis in an area where the object is disposed.

The predetermined value Lmin approximately indicates a diameter of the circular barcode 301. The size of the circular barcode 301 in the photographed image data is known, so that the Lmin is determined based on the size of the circular barcode 301 and the view angle of the CCD camera 14. In other words, if the line of the 1-pixels is smaller then the Lmin, the line is determined as different from the circular barcode 301, so that a width not less than the Lmin pixels is targeted.

S104

Next, in the lines of 0-pixels and 1-pixels in the y axis direction, central coordinates of an area where a line of successive 1-pixels includes not less than the Lmin pixels and not more than Lmax pixels are obtained. In this case, the y coordinate of the obtained central coordinates indicates a y coordinate posy of the central coordinates of the bottom of the object. The Lmax indicates the maximum value of the size of a single circular barcode 301 including a predetermined error.

S105

Projection in the x direction is performed again in the area where the line of successive 1-pixels includes not less than the Lmin pixels and not more than the Lmax pixels in the projection in the y direction. And central coordinates of an area where a line of successive 1-pixels includes not less than the Lmin pixels and not more than the Lmax pixels are obtained. In accordance with this, an x coordinate posx of the circular barcode 301 is obtained.

S106

A circumscribed rectangle of a circle having a radius r with the obtained posx and posy as the center thereof is extracted. The radius r includes the size of the known circular barcode 301, so that an image of the circular barcode 301 as shown in FIG. 37 is obtained.

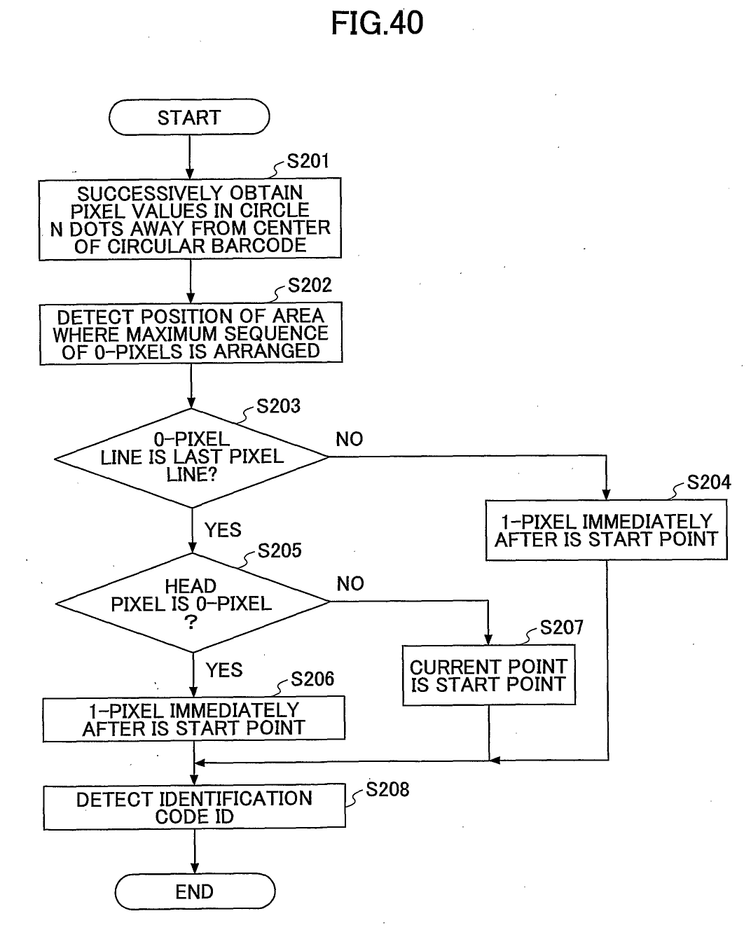

Next, description is given regarding a processing procedure of the object recognizing unit 22 with reference to a flowchart of FIG. 40. The image of the circular barcode 301 extracted by the object area extracting unit 30 is transmitted to the object recognizing unit 22. The object recognizing unit 22 analyzes patterns of the circular barcode 301 and recognizes the ID code and the position (direction) of the white portion.

S201

The object recognizing unit 22 handles a certain point as a start point, which is positioned at given n dots from the center (posx, posy) of the circular barcode 301 extracted by the object area extracting unit 30, and obtains pixel values from the start point successively in a determined circumferential direction in a circular manner.

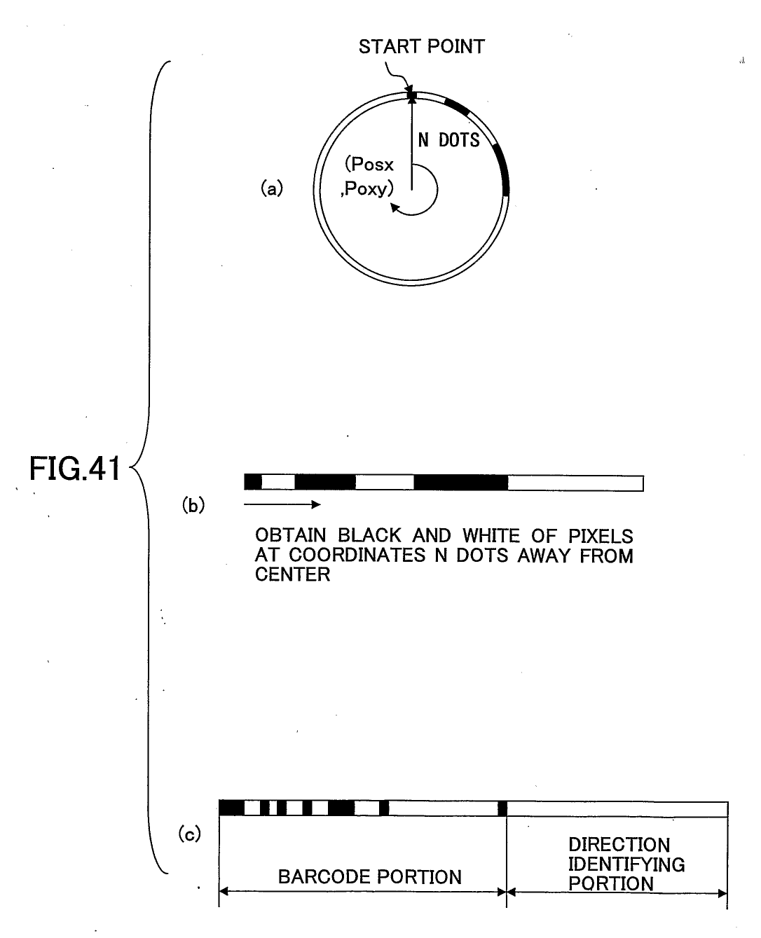

FIG. 41 shows a diagram for describing a pattern analysis in which the object recognizing unit 22 scans and processes pixels in the circumferential direction. As shown in FIG. 41-(a), the object recognizing unit 22 scans pixels in the clockwise direction with the certain point as the start point positioned at n dots from the center (posx, posy) of the circular barcode 301.

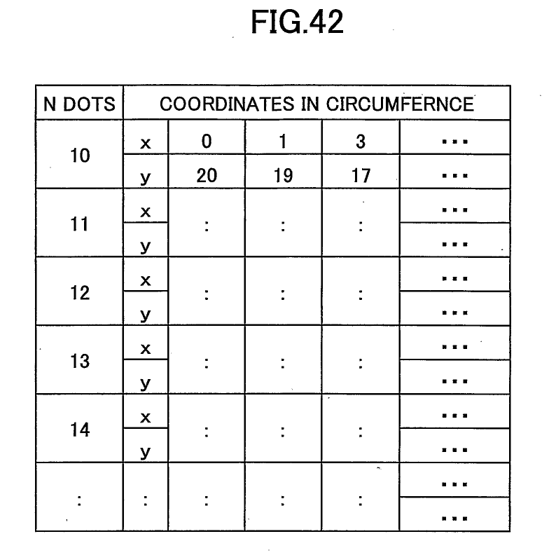

Operations of pixels in the circumferential direction may successively extract pixels based on the center (posx, posy) and the start point. However, as shown in FIG. 42, the amount of computing by the CPU can be reduced by referring to a polar coordinate table. In the polar coordinate table of FIG. 42, coordinates of circumferential positions are registered in a table in accordance with the number of dots n (when the radius is n dots) from the center.

The object recognizing unit 22 determines the pixel values of circumferential points based on a predetermined threshold value and converts pixels not more than the threshold value to 1-pixels and pixels more than the threshold value to 0-pixels. In accordance with this, a series of 1-pixels and 0-pixels is created when the process goes around the circumference. FIG. 41-(b) indicates 1-pixels in black and 0-pixels in white. The series of pixels as shown in FIG. 41-(b) is converted to a run length of 1 and 0 in accordance with a length thereof.

S202

As shown in FIG. 41-(c), the series of 1-pixels and 0-pixels includes a 0-pixel sequence area for identifying directions (a direction identifying portion) and a barcode portion for identifying the ID code, the barcode portion including 0-pixels and 1-pixels. The object recognizing unit 22 detects the position of an area where a maximum sequence of 0-pixels is arranged among the arrangement of pixels converted to the run length. In other words, by measuring a length of the 0-pixel sequence area (direction identifying portion) and the position thereof, the position of the white portion of the circular barcode 301 (hereafter simply referred to as a direction) is obtained.

Lengths of a series of 0-pixels and a series of 1-pixels created upon converting to a run length are measured and the longest white run is searched for. When the scanning of all coordinate lines of the circle with the radius of n dots is finished, the measurement of the lengths of the series of 1-pixels and 0-pixels are finished.

S203

Next, the object recognizing unit 22 determines whether the longest 0-pixel series is the last pixel series.

S204

If the longest 0-pixel series is not the last pixel series, a 1-pixel immediately after the longest 0-pixel series is a start point.

S205

If the longest 0-pixel series is the last pixel series, whether the pixel value of a head of the pixel series is a 0-pixel is examined.

S206

If the pixel value of the head of the pixel series is a 0-pixel, a 1-pixel immediately after is a start point.

S207

If the pixel value of the head of the pixel series is not a 0-pixel, a current point is a start point.

S208

Then, the object recognizing unit 22 detects an ID code based on the run length of the barcode portion.

The processing procedure of FIG. 40 has three steps, namely, converting pixels to a run length, then searching for the direction identifying portion, and analyzing the barcode portion. However, a maximum consecutive number (referred to as Zmax) of 0-pixels in the barcode portion is known, so that the direction and the ID code can be obtained upon converting to a run length.

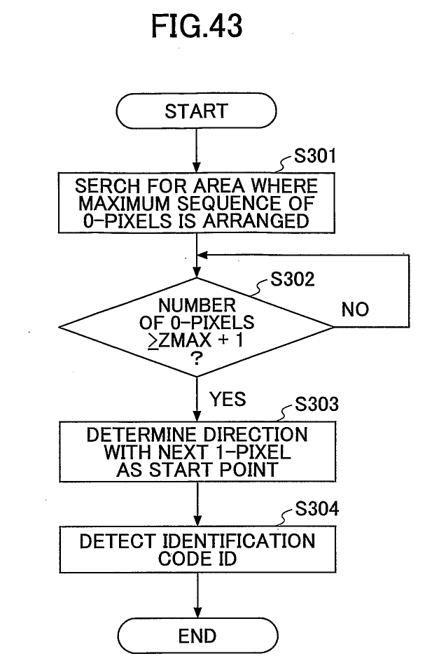

FIG. 43 is an example of a flowchart showing another form of the processing procedure of the object recognizing unit 22.

S301

If the image of the circular barcode 301 extracted by the object area extracting unit 30 is an image as shown in FIG. 37, scanning is started from a point in the vertical direction so as to search for an area where a maximum sequence of 0-pixels is arranged.

S302

The object recognizing unit 22 successively obtains circumferential pixel values and recognizes a direction identifying portion when the number of 0-pixels reaches the Zmax+1.

S303

The object recognizing unit 22 determines the next 1-pixel as the start point of the barcode portion. And the previous pixel of the start point in the barcode portion is determined to be the end point in the direction identifying portion, so that the direction of the circular barcode 301 can be identified.

S304

The object recognizing unit 22 scans around the circular barcode 301 and detects the ID code based on the run length of the barcode portion.

When the series of 1-pixels and 0-pixels is successively obtained from the start point of the barcode portion, the ID code and direction are obtained in a single scanning, since the series of 1 and 0 per se represents the ID code.

In this manner, in the present embodiment, the object recognizing unit 22 requires no dictionary for pattern matching and the like to detect the circular barcode 301. In addition, the rotation of the object can be detected by obtaining the direction in each frame of image data.

Object information (position, direction, and ID code) of the object obtained in the above processing is transmitted to the operation processing unit 23 of the application 24a.

Next, the application 24a is described. The operation processing unit 23 of the application 24a controls an image to be projected from the projector 13 based on the object information. Functions of the operation processing unit 23 are the same as in the first embodiment.

In the first embodiment, the operation processing unit 23 operates, based on the attribute information of the object, the image to be projected from the projection image forming unit 24. And the application 24a performs processing in accordance with the attribute information and the processing results are applied to the image to be projected.

In the present embodiment, the application 24a operates the image in accordance with the object information via the operation processing unit 23, performs processing based on the object information, and applies the processing results to the image in the same manner.

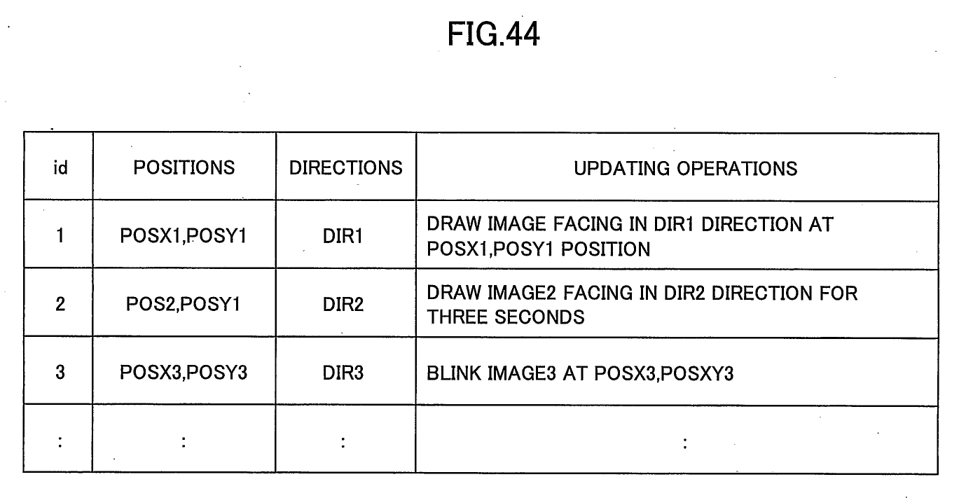

Contents of image operations are recorded in association with the object information in the operation correspondence table 31 included in the application 24a. FIG. FIG. 44 shows an example of the operation correspondence table. In the operation correspondence table, the contents of image operations are recorded in association with ID codes, positions, and directions.

For example, when an object having an ID code of 1 is placed at (Posx1, Posy1) facing in a dir1 direction, the operation processing unit 23 draws an image 1 at (Posx1, Posy1) facing in the dir1 direction. In the same manner, when an object having an ID code of 2 is placed at (Posx2, Posy2) facing in a dir2 direction, the operation processing unit 23 draws an image 2 facing in the dir2 direction for only three seconds. Also, when an object having an ID code of 3 is placed at (Posx3, Posy3) facing in a dir3 direction, the operation processing unit 23 blinks an image 3 at (Posx3, Posy3). The images 1 to 3 are registered in advance or can be displayed by user specification.

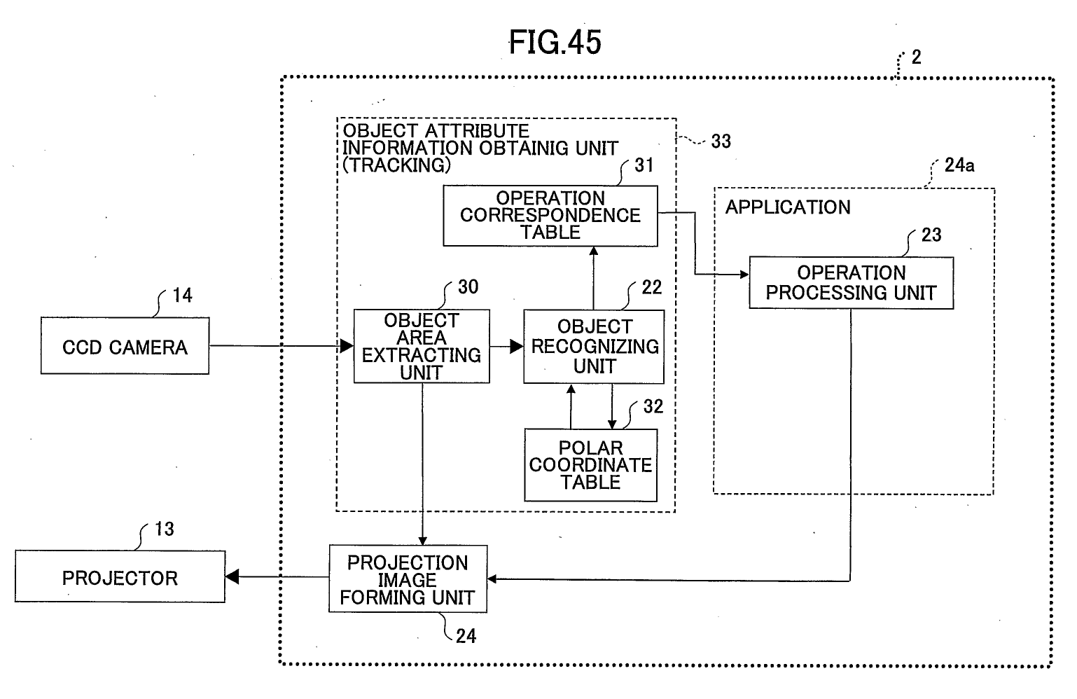

In the example of FIG. 36, although the application 24a stores the operation correspondence table 31 for associating the object information with the operation processing, the operation correspondence table 31 may be stored in the object attribute information obtaining unit 33. FIG. 45 is a functional diagram of the image displaying apparatus in a case where the object attribute information obtaining unit 33 stores the operation correspondence table 31. In the operation correspondence table 31, an application and ID codes of objects are registered in a corresponding manner. The object recognizing unit 22 refers to the operation correspondence table 31 after recognizing the object, opens only an operation correspondence table for the currently opened application, and hands the table to the application 24a.

In the present embodiment, the identification code attached to the object, for example, is constituted only using the circular barcode 301, so that it is possible to perform the same operations as in the image operations described in the first embodiment. In other words, the ID code constituted using the circular barcode 301 may be associated with attributes of a battery, resistor, capacitor, and the like. In this case, when objects having the circular barcode 301 are linked using a line segment, a circuit diagram is displayed from the operation processing unit. Also, when objects are linked using a single-headed arrow, it is possible to copy attributes to other attributes. When two objects are linked using a double-headed arrow, it is possible to switch the attributes of both objects. When plural objects are surrounded by a loop, it is possible to define the same attributes in objects having consecutive ID codes and to define the attributes in objects with undefined attributes. When a line segment is drawn from an object or objects are surrounded by a loop, it is possible to display object information and initialize attributes thereof as undefined. By determining the length of a line segment drawn from an object or rotating the object, it is possible to define numerical values of attributes. By placing or removing an object in a predetermined time, it is possible to use such an operation as a trigger for instructing the application 24a to perform a predetermined process. Further, it is possible to control and draw, based on an object, an image of a line segment drawn on the drawing plane 11b by the user.

According to the present embodiment, by using the circular barcode as an identification code of an object, scanning a circumference with a given radius from a center thereof, and converting to a run length, it is possible to recognize a barcode and obtain numbers thereof (ID code). Since barcodes have many identification numbers, various types of object information can be registered (tens of thousands, for example). Further, with the use of a direction identifying portion, the direction of an object can be readily determined. A barcode portion indicates simple binary numbers, so that the barcode portion can be used as an ID code depending on usage when it is converted to n-ary numbers where appropriate. In the circular barcode, the circumference with the given radius from the center may be scanned, so that it is not necessary to use the whole bottom of an object as a figure for recognition. In the present embodiment, it is not necessary to increase the resolution of the CCD camera 14 in order to increase the number of objects to be identified as long as the CCD camera 14 is capable of identifying the barcode portion, and the number of patterns for pattern matching is not increased. Further, in the present embodiment, if the resolution of the CCD camera 14 is increased, a width of identifiable bars can be reduced, so that it is possible to increase the number of sets of object information that can be registered.

### EXAMPLE 6

Although the image displaying apparatus identifies object based on the identification code, it is necessary for the user to confirm types of information possessed by the objects in TUI. For example, the user is capable of confirming information about the object (building forms, for example) described with characters and the like. However, it is preferable to represent object in terms of design so as to recognize the object in a more intuitive manner.

In other words, when operating an image shown based on the identification code of the object, if information shown by the object is changed or an application using the TUI is changed, an object form must be creased in accordance with the purpose thereof.

In this respect, as shown in FIG. 46, in the case of a front type for projecting an image from above the projection plane 11a, it is possible to have various forms (appearances) using the same object by projecting information (figures, characters, and the like) represented by the object on the object without recreating the forms of the object.

However, the front projection is problematic in that projected light is blocked and visibility is reduced when the user operates the object. In view of this, by making the object identifiable for the user in the rear projection using a general-purpose object, operability and visibility are improved.

First, in the present embodiment, a cylindrical object including mirror-like reflective surfaces on the sides thereof is used as an object. In addition, FIG. 36 or FIG. 45 may be used as a functional diagram thereof.

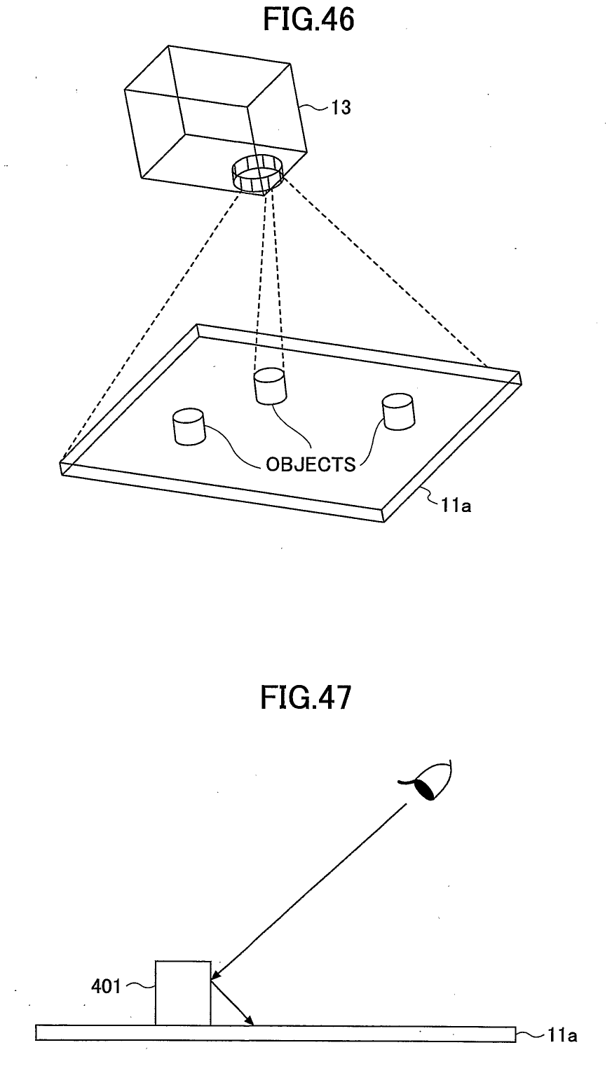

FIG. 47 is a diagram showing a schematic relationship between the user's view and the cylindrical object placed on the drawing plane 11a.

A cylindrical object 401 has mirrors on the sides thereof, so that a landscape of surroundings is reflected on the sides. When the user uses the image displaying apparatus, it is assumed that the cylindrical object is generally viewed at an angle of about 30 to 60 degrees. In this case, an image projected on the drawing plane 11b where the cylindrical object is placed is reflected on the mirror surfaces of the sides of the cylindrical object.

However, the image reflected on the sides of the cylindrical object is converted from a plane surface to a curved surface, so that the image is distorted. In the present example, the image reflected on the sides of the cylindrical object is used. Thus, it is possible for the user to discriminate each cylindrical object by projecting a distorted image (hereafter referred to as an anamorphic image) on the circumferences of the cylindrical objects placed on the drawing plane 11a such that the image is appropriately reflected (without distortion) on the mirror surfaces of the cylindrical object.

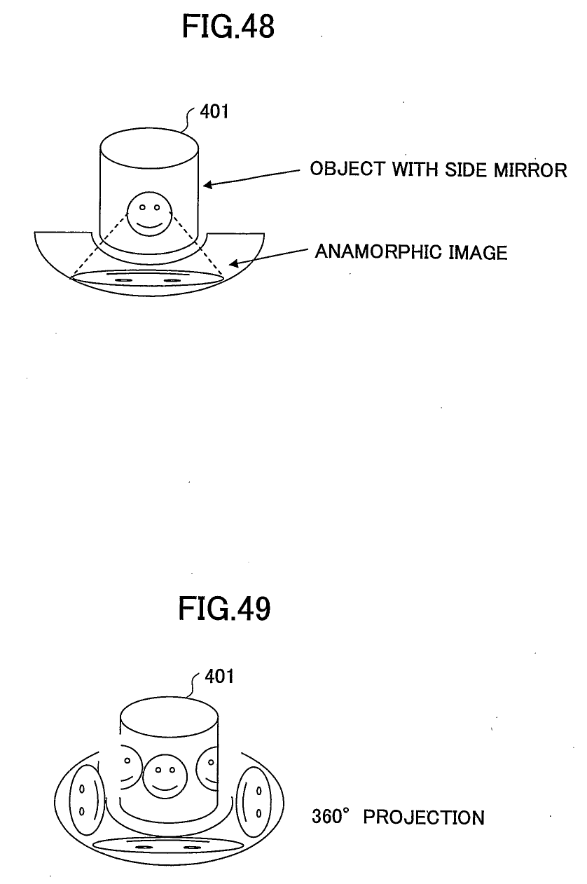

FIG. 48 is a diagram showing how the anamorphic image projected on the drawing plane 11a is reflected on the cylinder. As shown in FIG. 48, the distorted anamorphic image is appropriately displayed when it is reflected on the cylindrical surface.

Since the physical forms such as the radius of a circle, height, and the like of the cylindrical object are known, a transformation formula of an anamorphic image for forming an appropriate image on the sides of the object is uniquely determined. By inputting a projection image to the formula, an anamorphic image to be projected is obtained.

When the object recognizing unit 22 detects the object information (position, direction, and ID code), the operation processing unit 23 causes the projection image forming unit 24 to project an anamorphic image in accordance with the ID code of the object on the circumference of the object depending on the direction of the object.

A range to project the anamorphic image may be a 360-degree area around the circumference of the cylindrical object 401 or only a portion may be projected where appropriate.

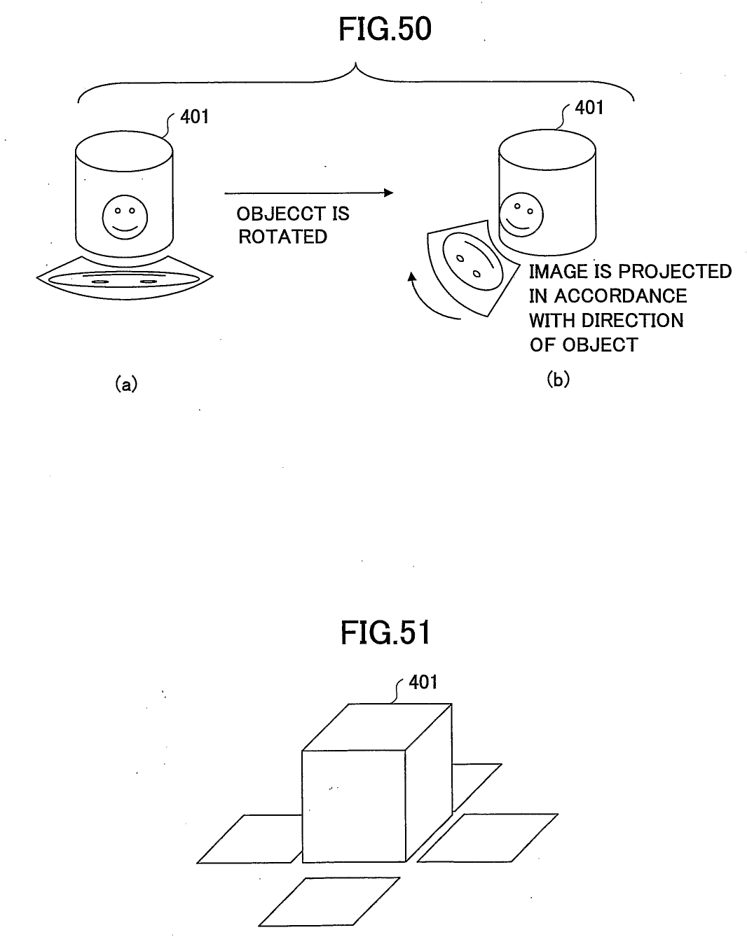

FIG. 49 shows an example of the anamorphic image projected on the 360-degree area around the circumference of the cylindrical object 401. FIG. 50 shows an example of the anamorphic image projected on a portion of the cylindrical object 401. As shown in FIG. 50, when the anamorphic image is projected on the portion of the cylindrical object 401, the user is capable of recognizing the direction of the cylindrical object 401 based on the position of a projection image reflected on the cylindrical object 401. Thus, when the anamorphic image is rotated and displayed in accordance with the direction of the cylindrical object 401, the user is capable of recognizing the direction of the cylindrical object 401.

By forming or selecting an image projected in accordance with an intended use of the object, it is possible to use a general-purpose cylindrical object for various intended uses (applications) without actually forming the object into intended forms.

Further, the object may be a cuboid such as a prism. FIG. 51 shows, an example of a prismatic object 402. In the case of the prismatic object 402 as shown in FIG. 51, directions to be viewed from the surroundings are limited as compared with cylindrical objects. However, if a subject to be represented has a front surface, side surfaces, and a back surface, distinctively, it is preferable to use the prismatic object 402.

The operation processing unit 23 projects an image of the front surface of the subject for a front surface of the object when viewed from the user, images of the side surfaces of the subject for side surfaces, and an image of the back surface of the subject for a back surface, whereby each surface of the prismatic object reflects the image for each surface.

When the direction of the projection image is changed in accordance with the direction of the object, the user is capable of obtaining effects such that the actual subject is viewed.

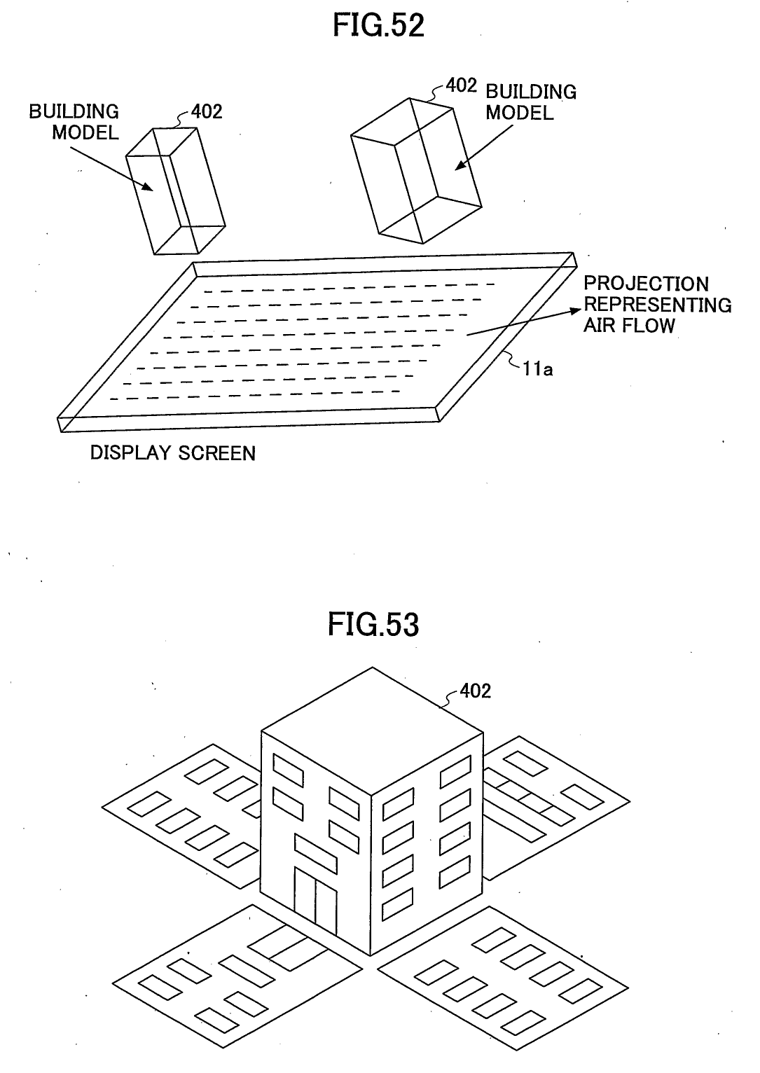

FIG. 52 is a diagram for describing a case where the prismatic object is used in an application for simulating a flow of air. In the case of an application in which the prismatic object 402 is disposed on the drawing plane 11b and how air of a city is flown and the like are simulated, an image of a building is projected on the object.

The building has the front surface, side surfaces, and the back surface, so that the operation processing unit 23 performs projection such that appropriate images are reflected on each surface of the prismatic object. FIG. 53 shows a projection image in which the images of the building are projected on each surface of the prismatic object.

When the object is rotated, the operation processing unit 23 rotates the projection image in accordance with the direction of the object. Thus, the same images are constantly reflected on the same surfaces of the object, so that the user is capable of obtaining effects such that an actual subject is viewed.

As mentioned above, according to the present example, it is not necessary to prepare an object for each subject represented by the object and a general-purpose TUI object is realized. By using the cylindrical object 401 and the prismatic object 402 in a combined manner, it is possible to represent various subjects in a single application. Also, if the subject is fixed so as to be used in a specific application, the actual form of the subject is prepared as an object and a general-purpose object can be used with respect to an object of a floating subject.

In addition, the object having mirror-like reflectors in the present example can be preferably applied to any of examples 1 to 5 as it is a feature in terms of appearances.

### EXAMPLE 7

When the object in TUI is provided with versatility, an object may include a transparent material. The transparent material includes a material with a high transmission such as acryl, glass, and the like.

In the present example, the object including the transparent material has a cylindrical form. In addition, FIG. 36 or FIG. 45 may be used as a functional diagram.

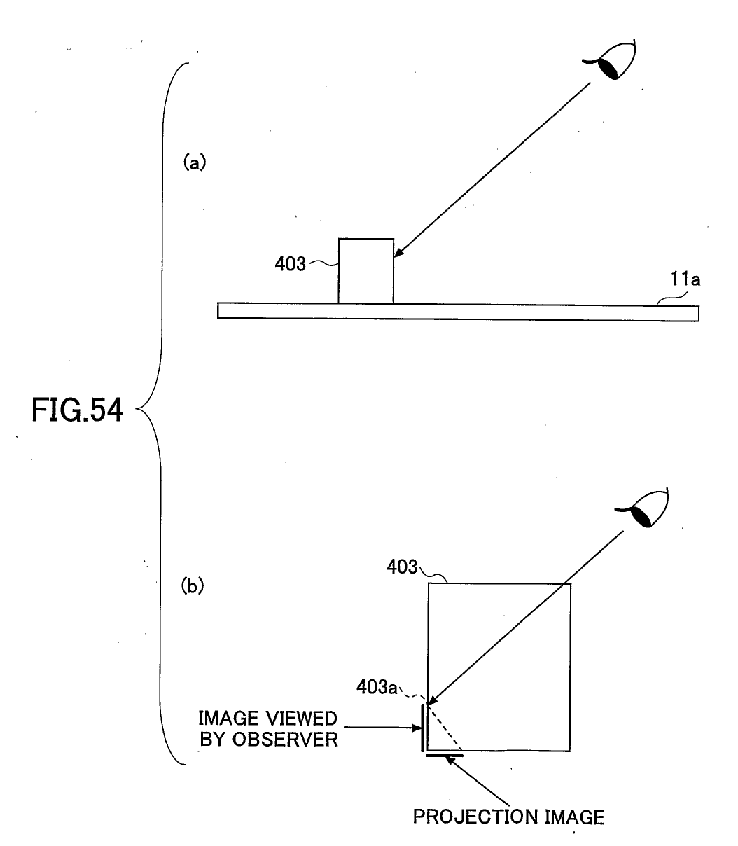

FIG. 54-(a) is a diagram showing how the user observes a transparent object 403 at a predetermined angle (30 to 60 degrees, for example). As shown in FIG. 54-(a), when the transparent object 403 is observed, the inner surface of the transparent object 403 functions as a cylindrical mirror surface.

FIG. 54-(b) is a diagram showing a projection image observed by the user via the transparent object 403. As shown in FIG. 54-(b), an image projected on a bottom of the transparent object 403 is observed by the user through reflection on an inner surface 403a of the transparent object 403 disposed on a remote side relative to the user's view. Thus, when the transparent object 403 is disposed, the user observes that the image of the bottom portion thereof is reflected on the inner surface of the side of the cylinder.

The reflected image is inverted and reversed as compared with a projected image and a reflective surface of the transparent object 403 is a curved surface. Thus, by distorting the image to be projected on the bottom of the transparent object 403 in advance such that it is inverted and reversed, the user observes an appropriate original image on the inner surface of the transparent object.

When the object recognizing unit 22 detects the object information (position, direction, and ID code), the operation processing unit 23 distorts an image corresponding to the ID code such that the image is inverted and reversed, and causes the projection image forming unit 24 to project the image on the bottom of the object in accordance with the direction of the image.

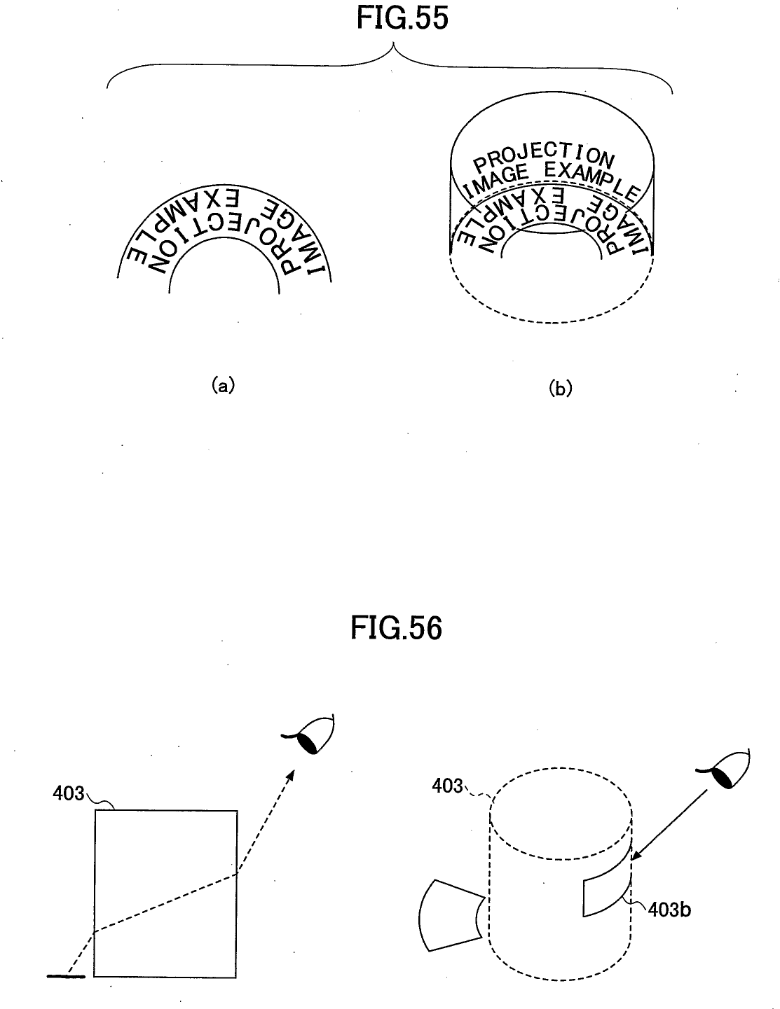

FIG. 55-(a) shows an example of the image projected on the bottom of the transparent object 403, the image being distorted such that it is inverted and reversed in advance. FIG. 55-(b) shows an image observed by the user, the image being projected on the bottom and reflected on the inner surface of the transparent object 403. As shown in FIG. 55-(b), when the transparent object 403 is used, the user is capable of recognizing the object without being conscious of the inversion, reversion, or distortion resulting from the reflection.

The side surface of the transparent object 403 also functions as a cylindrical lens. FIG. 56 is a diagram showing how the transparent object 403 functions as the cylindrical lens. In the cylindrical lens, an image on the opposite side of the transparent object 403 when viewed from the user is reflected on a side surface 403b on the user side.

The reflected image as shown in FIG. 56 is also distorted such that it is reversed as compared with a projected actual image. Thus, by projecting an image distorted such that it is reversed in advance, the user is capable of recognizing the object without being conscious of the reversion or distortion resulting from the reflection.

A circular barcode for identifying the object can be attached to the bottom of the object, so that the image displaying apparatus is capable of identifying the object.

Further, it is possible for the user to discriminate the transparent object 403 in accordance with an image to be projected; so that the transparent object 403 can be used as a general-purpose object and is capable of representing various objects combining the reflection on the inner surface with the transmission effects using the cylindrical lens and also combining the projection image with colors, forms, characters, and the like. Although the cylindrical transparent object 403 is described in the present example, when a prismatic transparent object is used, the object can also be identified in the same manner.

The object including the transparent material in the present example can be preferably applied to any of examples 1 to 5 as it is a feature in terms of appearances.

### EXAMPLE 8

When the transparent object is used as in example 7, the user is capable of observing, above the object, the image on the bottom of the object. However, the identification code for identifying an object is attached to the bottom of the object, so that the image is projected only on a margin portion thereof.

When the image is projected on the margin portion, the identification code according to the first embodiment has little margin portion, so that it is preferable to use the circular barcode 301 described in example 5. Any of FIG. 2, FIG. 36, or FIG. 45 may be used as a function diagram thereof.

The circular barcode 301 has wedge-like figures arranged, the figures gradually becoming thinner toward a center thereof. When the circular barcode 301 is sectioned in a concentric manner, each concentric circle has the same ratio of black to white. Thus, either the vicinity of the central portion or the vicinity of the circumferential portion of the circular barcode 301 may be used as long as each line of the circular barcode 301 can be resolved from an image photographed using the CCD camera 14. In other words, it is sufficient to decode patterns along a coordinate line of a circle with a radius of n dots.

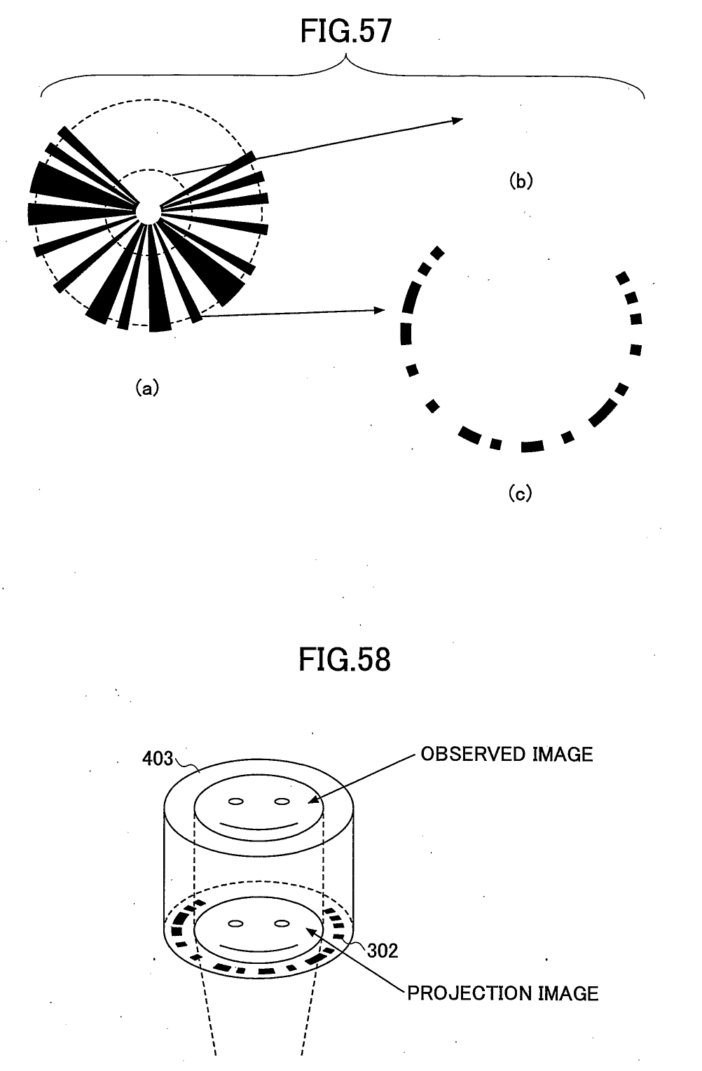

FIG. 57-(a) shows an example of the circular barcode 301, FIG. 57-(b) shows the vicinity of the central portion of the circular barcode 301 which has been extracted, and FIG. 57-(c) shows the vicinity of circumferential portion of the circular barcode 301 which has been extracted.

If the vicinity of the central portion is used as in FIG. 57-(b), it is possible to project an image on an outer side thereof. If the vicinity of the circumferential portion is used as in FIG. 57-(c), it is possible to project an image on an inner side thereof. If the circumferential portion of the circular barcode 301 is used, line thickness and space are increased, so that the CCD camera 14 is provided with a sufficient resolution.

When the object recognizing unit 22 detects the object information (position, direction, and ID code), the operation processing unit 23 causes the projection image forming unit 24 to project an image in accordance with the ID code of the object on an inner side of the circular barcode 301 depending on the direction of the object.

FIG. 58 is a diagram showing a circular barcode 302 attached to a circumferential portion of the transparent object 403 and an image projected on an inner side thereof. The circular barcode 302 is attached or printed on the circumference of the bottom of the transparent object. The central portion thereof can be used as a margin. Thus, by projecting the image, the observer is capable of recognizing a subject represented by the object from an image reflected on an upper surface of the object.

The object including a transparent material and the method for attaching the circular barcode according to the present example can be applied to any of examples 1 to 5 as they are features in terms of appearances.

As mentioned above, the image displaying apparatus according to the present embodiment is capable of registering a great deal of object information by identifying the object based on the circular barcode. Also, the image displaying apparatus is capable of readily determining the position of the object due to the direction identifying portion. Further, by using a mirror or a transparent object, it is possible to employ the image displaying apparatus for various types of applications with a general-purpose object.

### Third Embodiment

A third embodiment differs from the first embodiment in that two CCD cameras with different resolution are included and that one camera detects the position of the object and the other camera detects the identification information and movement information of the object. However, other features are the same, so that those different features will be described.

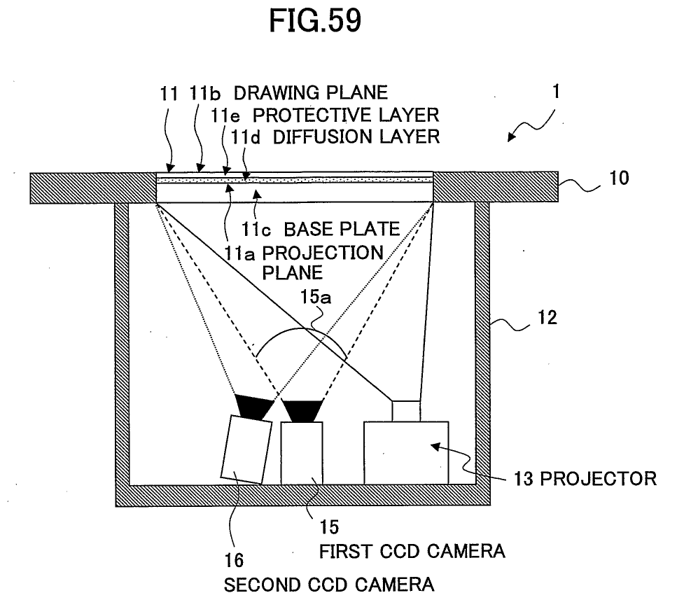

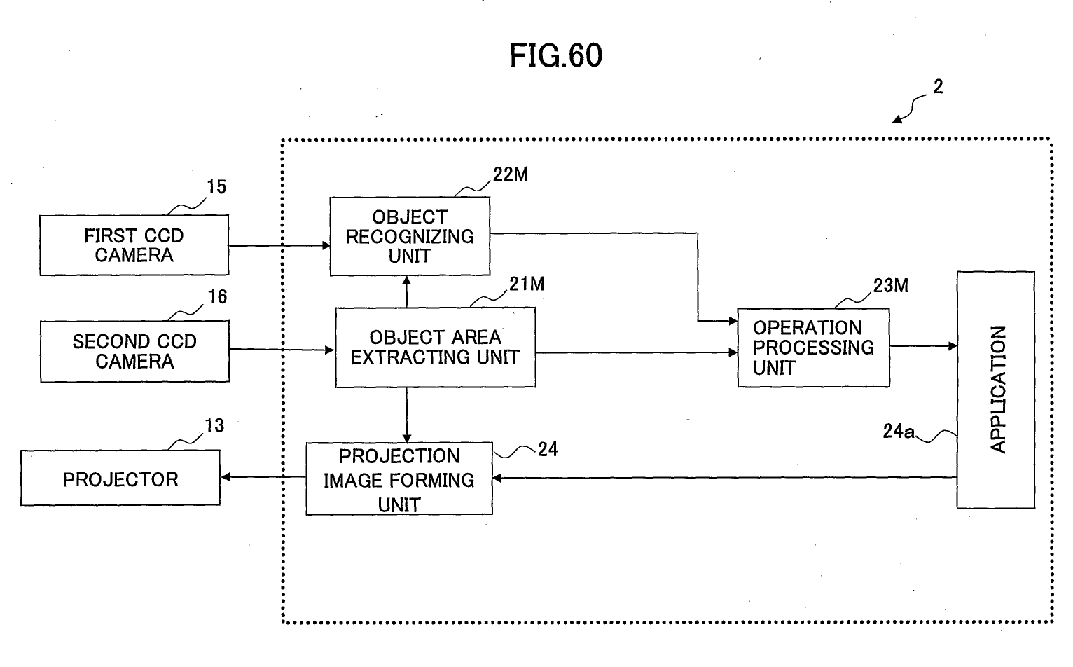

FIG. 59 and FIG. 60 are diagrams showing the third embodiment of the image displaying apparatus according to the present invention. FIG. 59 shows a schematic cross-sectional view of a display unit and FIG. 60 shows a schematic configuration diagram of a body unit.

As shown in FIG. 59, the display unit of the image displaying apparatus according to the third embodiment includes the plane unit 10 having the screen 11 embedded in the central portion thereof, the casing 12 for supporting the plane unit 10, the projector 13 disposed in the inside of the casing 12, the projector 13 projecting an image on the screen 11, a first CCD camera 15 (corresponding to the imaging unit according to the present invention) disposed on a position such that an entire back surface side of the screen 11 is included in a view angle 14a, the first CCD camera photographing the screen 11 from the bask surface side, and a second CCD camera 16 (corresponding to the object detecting unit according to the present invention) disposed on a position such that the entire back surface side of the screen 11 is included in a view angle 15a, the second CCD camera photographing the screen 11 from the bask surface side.

In order to detect a moving object and recognize an identification code attached to a bottom of the detected object using a single CCD camera, it is necessary to use a CCD camera with a high resolution. However, when the object placed on the screen is detected using the CCD camera with a high resolution, the detection takes time. Thus, in the present embodiment, the projection plane is photographed, while separating the identification code detection which must be performed with high accuracy using a high resolution CCD camera even if it takes time from the position detection which can be performed in a short time with low accuracy using a low resolution CCD camera.

As shown in FIG. 60, the body unit 2 of the image displaying apparatus according to the third embodiment includes an object area extracting unit 21M having an interface to the second CCD camera 16, the object area extracting unit 21M binarizing imaging data on an image photographed using the second CCD camera 16 and extracting position information of the object placed on the screen, an object recognizing unit 22M having an interface to the first CCD camera 15, the object recognizing unit 22M binarizing imaging data on an image photographed using the first CCD camera 15, extracting information about an outline of the bottom and the identification code, and performing pattern matching between the extracted identification information and the dictionary for pattern recognition, thereby obtaining identification information about the object and the direction of the object, the projection image forming unit 24 having an interface to the projector 13, the projection image forming unit 24 forming, in accordance with the predetermined application program 24a, an image to be projected from the back surface side of the screen 11 via the projector 13, and an operation processing unit 23M for operating, based on the position information extracted in the object area extracting unit 21M and the identification information and the information about the direction of the object obtained in the object recognizing unit 22M, the image to be projected from the projector, adding new contents and actions to the image formed in the projection image forming unit 24 in accordance with the predetermined application program 24a.

The image formed in the body unit 2 is projected on the back surface side of the screen 11 using the projector 13 and a person observing from the front surface side of the screen 11 is capable of viewing the projected image.

Moreover, when the object having the identification code (a mark identified based on the form and size thereof, for example) in which a pattern is recorded in advance attached to the bottom thereof is placed on the front surface side of the screen 11, the object area extracting unit 21M detects the position from the imaging data photographed using the second CCD camera 16 and transmits the information to the operation processing unit 23M. The operation processing unit 23M transmits data for projecting a uniformly white image on an area including the position where the object is placed to the projection image forming unit 24. On the other hand, the object recognizing unit 22M obtains identification information about the object from the imaging data on the outline of the bottom within the uniformly white area photographed using the first CCD camera 15 with a high resolution and the identification code, obtains movement vectors from the imaging data of each time, and transmits the information to the operation processing unit 23M. The operation processing unit 23M performs operations for adding a new image based on the identification information and providing movement in accordance with the movement vectors to the image formed in the projection image forming unit 24.

The present invention is not limited to the specifically disclosed embodiment, and variations and modifications may be made without departing from the scope of the present invention.

The present application is based on Japanese priority application No. 2005-164414 filed Jun. 3, 2005, and Japanese priority application No. 2006-009260 filed Jan. 17, 2006, the entire contents of which are hereby incorporated herein by reference.

1. An image displaying apparatus comprising:
a photographing unit configured to photograph an image on a screen;
a projection image generating unit generating said image to be projected on said screen;
an image extracting unit extracting identification information from said image photographed by said photographing unit, said identification information concerning object or figure information;
an object recognizing unit recognizing attribute information from said identification information concerning said object information extracted by said image extracting unit;
a figure recognizing unit recognizing characteristic information from said identification information concerning said figure information extracted by said image extracting unit; and
an operation processing unit operating said projection image generating unit based on said attribute information and characteristic information.

2. The image displaying apparatus according to claim 1, wherein
said operation processing unit includes an attribute information storing unit in which said attribute information is stored in association with said identification information, and
said operation processing unit defines, based on the types of said figure or the size of said figure, said attribute information stored in said attribute information storing unit.

3. The image displaying apparatus according to claim 1, wherein
said operation processing unit operates, based on said attribute information obtained by said object recognizing unit, said projection image generating unit such that an object image of said object is generated, or operates, based on the types of said figure recognized by said figure recognizing unit, said projection image generating unit such that a figure image of said figure is generated.

4. The image displaying apparatus according to claim 2, wherein
said object recognizing unit includes a unit obtaining position information about said object, and
said operation processing unit defines, based on the types of said figure recognized by said figure recognizing unit and the position information about said object obtained by said unit obtaining position information about said object, attribute information about an object stored in said attribute information storing unit.

5. The image displaying apparatus according to claim 1, wherein
said object recognizing unit detects the number of detachment/attachment of said object on said projection plane or said back surface thereof in a predetermined time, and
said operation processing unit performs processing determined in advance based on said number of detachment/attachment and operates said projection image generating unit such that an image showing a relevant processing result is generated.

6. The image displaying apparatus according to claim 2, wherein
said operation processing unit performs, in accordance with processing on said drawn figure detected by said figure recognizing unit, predetermined-processing on the attribute information about said object defined based on the types of said figure.

7. The image displaying apparatus according to claim 2, wherein
said operation processing unit determines, in accordance with the identification information about said object and order of the obtained types of said figure, whether to define said attribute information in said attribute information storing unit.

8. The image displaying apparatus according to claim 1, wherein
said identification information includes a one-dimensional barcode arranged in a circular manner.

9. The image displaying apparatus according to claim 8, wherein
a margin having not less than a predetermined length is disposed from an end point to a start point of said one-dimensional barcode.

10. The image displaying apparatus according to claim 9, wherein
said object recognizing unit detects a rotation of said object based on a position of said margin.

11. The image displaying apparatus according to claim 8, wherein
said object recognizing unit scans said one-dimensional barcode in a circumferential direction and extracts said identification information.

12. The image displaying apparatus according to claim 1, wherein
said object has a cylindrical or prismatic form including a mirror-like reflector on a side surface thereof.

13. The image displaying apparatus according to claim 1, wherein
said object has a cylindrical or prismatic form including a transparent material.

14. The image displaying apparatus according to claim 12, wherein
said projection image generating unit projects an image on the periphery of said object, said image representing an appearance of a relevant object.

15. The image displaying apparatus according to claim 13, wherein
said projection image generating unit projects an inverted and reversed image of an image on a bottom of said object, said image representing information about a relevant object.

16. The image displaying apparatus according to claim 13, wherein
said projection image generating unit projects an image on an area of a bottom of said object where said one-dimensional barcode is not arranged, said image representing information about a relevant object.

17. The image displaying apparatus according to claim 1, wherein
said photographing unit photographs a projection plane on which an image is projected, an object disposed on a back surface thereof, or a drawn figure.

18. The image displaying apparatus according to claim 1, wherein
said image extracting unit extracts said identification information about said object or figure information about said figure from imaging data photographed by said photographing unit.

19. The image displaying apparatus according to claim 1, wherein
said operation processing unit operates said projection image generating unit based on said attribute information recognized by said object recognizing unit and the types of said figure or the size of said figure recognized by said figure recognizing unit.
